(19) United States
(12) Patent Application Publication
(10) Pub. No.: US 2014/0018999 A1
(43) Pub. Date: Jan. 16, 2014

(54) EXTENDED SMART DIAGNOSTIC CLEAT

(71) Applicants: Douglas E. Adams, West Lafayette, IN (US); Tiffany Lynn Di Petta, Rochester, MI (US); David J. Koester, Lafayette, IN (US)

(72) Inventors: Douglas E. Adams, West Lafayette, IN (US); Tiffany Lynn Di Petta, Rochester, MI (US); David J. Koester, Lafayette, IN (US)

(73) Assignee: PURDUE RESEARCH FOUNDATION, West Lafayette, IN (US)

(21) Appl. No.: 14/006,040

(22) PCT Filed: Mar. 21, 2012
(86) PCT No.: PCT/US2012/029954

§ 371 Date: Sep. 18, 2013

Related U.S. Application Data
(60) Provisional application No. 61/454,800, filed on Mar. 21, 2011.
(60) Provisional application No. 61/602,407, filed on Feb. 23, 2012.

(51) Int. Cl. B60W 40/06; B60W 50/02

(52) U.S. Cl. CPC B60W 40/06; B60W 50/02
USPC 701/31.4

(57) ABSTRACT

Methods and apparatus for diagnosing the condition of a vehicle. Some embodiments include providing an input to a vehicle suspension similar to an impact, and then measuring the response of the vehicle as it drives over an instrumented member. The motion of the instrumented member is recorded and corrected, and in some embodiments a fault index is calculated. The fault index can be displayed to a user to indicate a maintenance condition of the vehicles, such as a worn or broken component.

### CROSS REFERENCE TO RELATED APPLICATION

This application claims the benefit of priority to U.S. Provisional Patent Application Ser. No. 61/454,800, filed Mar. 21, 2011 and U.S. Provisional Patent Application Ser. No. 61/602,407, filed Feb. 23, 2012, both of which are incorporated herein by reference.

### FIELD OF THE INVENTION

Various embodiments of the present invention pertain to apparatus and methods for diagnosing the status of a multidegree of freedom system, and some embodiments pertain to analysis of wheeled vehicles.

### BACKGROUND

Wheeled vehicles, such as the high mobility multi-purpose wheeled vehicle (HMMWV), are subjected to a wide range operational loading conditions. These vehicles are expected to function on various terrains from sand dunes to mountainous regions to highways. Also, vehicles are subjected to other varying conditions such as changes in payload, changes in tire pressure, and other factors. As a result, mechanical faults can occur in the wheel ends, suspension, and frame. The occurrence of faults in ground vehicles leads to high operation and support costs. In fact, the U.S. Department of Defense spent approximately ⅗th of its 500 billion dollar budget in 2006 on operation and support costs. The most commonly used maintenance techniques are (a) run-to-failure maintenance, which prescribes maintenance only after a failure occurs, and (b) preventive maintenance, which prescribes that service be conducted routinely to avert failure. However, the run-to-failure approach can result in increased maintenance costs because an entire subsystem (suspension) may need to be replaced instead of just one damaged component (tie bolt) if failure takes place. Preventive maintenance can be expensive because it is based on reliability predictions of the average time to failure for a fleet of vehicles, and such predictions can be conservative. For example, preventive maintenance is often carried out when convenient, so healthy as well as damaged system components may be replaced during these maintenance actions leading to part shortages and higher inventory costs.

Condition-based maintenance (CBM) is an approach that makes maintenance decisions based on the condition or health of an individual vehicle and its components. CBM is meant to reduce unnecessary maintenance while ensuring that proactive maintenance is conducted when needed to prevent failure. This method aims to increase the availability of vehicles at a lower cost. However, FIG. 1 illustrates that CBM usually requires that data be collected on individual vehicles and components, and this data must be analyzed amidst operational variations to diagnose the vehicle condition.

There are two difficulties with this onboard condition monitoring approach. First, the number of datasets required to develop a library of possible healthy signatures extracted from an N-dimensional sensor suite on a vehicle given M terrains on which that vehicle can operate is of order M^{N}. For example, 6 sensors over 10 terrains would require that one million datasets be used to establish a fully populated reference set for fault detection. If 240 datasets were acquired each day on average, then it would take 11 years to develop this library of healthy signatures for each individual vehicle. This large number of datasets would be needed to characterize the normal operational response of the vehicle due to the non-stationary nature of the loading. Second, many vehicles are not equipped with sensors nor the acquisition systems to acquire, process, and store data; therefore, to implement condition-based maintenance, vehicles would need to be equipped with instrumentation leading to high costs.

What is needed are methods, apparatus, and systems that improve the detection of faults in a vehicle. Various embodiments of the present invention do this in novel and unobvious ways.

### SUMMARY OF THE INVENTION

Various embodiments of the present invention pertain to improved methods for detecting worn or faulted components on a vehicle.

Various other embodiments of the present invention pertain to simplified methods of testing a vehicle.

One aspect of the present invention pertains to an apparatus for analyzing a vehicle. Some embodiments include a first separable segment of driving surface, said first segment having a shape adapted and configured to locally elevate a vehicle driven over said first segment. Other embodiments further include a second separable segment of driving surface, said second segment having a top surface adapted and configured to be driven on by a wheeled vehicle, said second segment being located proximate to said first segment. Yet other embodiments include a motion sensor providing a signal corresponding to motion of said second segment. Still other embodiments include a computer receiving the signal and having software that analyzes the signal.

Another aspect of the present invention pertains to a method for analyzing a vehicle on a roadway. Some embodiments further include providing a portable segment of driving surface located proximate to a local elevational change in the roadway, and a sensor providing a signal corresponding to the response of the segment. Other embodiments include driving the vehicle first over the elevational change at a vehicle velocity sufficient to cause vehicle response. Yet other embodiments include driving the responding vehicle over the segment, recording the signal during said driving over the segment, and correcting the recorded signal for the response of the vehicle.

Yet another aspect of the present invention pertains to an apparatus for analyzing a wheeled vehicle having a wheelbase and a front track. Some embodiments include a first panel having a substantially flat top surface adapted and configured to be driven on by the vehicle, said first panel having a length less than the wheelbase. Other embodiments further include a second panel having a substantially flat top surface adapted and configured to be driven on by the vehicle, said second panel having a length less than the wheelbase. Yet other embodiments further include a first motion sensor attached to said first panel and providing a signal corresponding to motion of said first panel. Still other embodiments include a second motion sensor attached to said second panel and providing a signal corresponding to motion of said second panel;

It will be appreciated that the various apparatus and methods described in this summary, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions. Further, some of the figures shown herein may have been created from scaled drawings or from photographs that are scalable. It is understood that such dimensions, or the relative scaling within a figure, are by way of example, and not to be construed as limiting.

FIG. 1-1 is a Illustration of traditional approach for diagnosing faults in ground vehicles using onboard condition monitoring data.

FIG. 1-2 is an illustration of a method according to one embodiment of the present invention.

FIG. 1-3 is a photographic representation of a vehicle.

FIG. 2: Illustration of apparatus and system for measuring ground vehicle dynamic response through wheels to identify mechanical faults (motion sensors are indicated).

FIG. 3: Photograph of apparatus according to one embodiment of the present invention along with HMMWV about to traverse the cleats. Motion sensors are visible on the plates.

FIG. 4: (a) Photograph of HMMWV control arms, and (b) frame rails, both instrumented with accelerometers.

FIG. 5: Illustration of modal impact locations along plate with different tire positions where the position of the vehicle tire is indicated.

FIG. 6-1: CMIF plots for (a) accelerometer 3 on the driver's side plate and (b) accelerometer 4 on the passenger's side plate and the maxima indicate the resonance frequencies.

FIG. 6-2 is a block diagram representation of a method of analyzing a vehicle according to one embodiment of the present invention.

FIG. 6-3 is a block diagram representation of a method of analyzing a vehicle according to one embodiment of the present invention.

FIG. 6-4 is a block diagram representation of a method of analyzing a vehicle according to one embodiment of the present invention.

FIG. 7: Lower control arm average response in the Z-direction (vertical) for front tire and rear tire crossings showing that rear suspension is stiffer than front suspension.

FIG. 8: Magnitude of averaged scaled acceleration DFT in the Z-direction for the four sensors on the chassis as well as the two sensors on the passenger front and rear lower control arms; bounce, pitch, and wheel hop natural frequencies are indicated.

FIG. 9: Operational deflection shapes at the three peaks indicated in FIG. 8 using Eq. (2).

FIG. 10: Average DFT magnitudes for accelerometer 4 on the PASSENGER plate for front (dark gray) and rear wheel (light gray) excitations in the no-fault (baseline) case according to one embodiment of the present invention.

FIG. 11: Average DFT magnitudes for accelerometer 3 on the DRIVER plate for front (dark gray) and rear wheel (light gray) excitations in the no-fault (baseline) case according to one embodiment of the present invention.

FIG. 12-1: Power spectral densities for accelerometer 4 in Z direction due to passenger front tire excitation for each front passenger tire pressure case according to one embodiment of the present invention.

FIG. 12-2: Mean baseline frequency spectra from sensor 3 (driver's side) vertical direction acceleration for a front axle wheel crossing measured using long cleat for baseline data series including (1) first 30, (2) second 11, (3) third 11, (4) fourth 11, and (5) fifth 11 data series, and (6) 10 psi under pressure in driver front tire indicating frequency ranges in which change due to fault are observed.

FIG. 12-3 presents an expansion of the plot of FIG. 12-2 in the range of 20 to 40 Hertz.

FIG. 12-4 is an expansion of the spectra of FIG. 12-2 in the range of 60 to 80 Hertz.

FIG. 13: Fault index according to one embodiment for accelerometer 4 in Z direction due to passenger front tire excitation for each front passenger tire pressure case (20 psi is nominal case; pressure cases go from left to right in increasing tire pressure levels).

FIG. 14-1: Fault index according to another embodiment as a function of tire pressure fit with a second order polynomial.

FIG. 14-2: Fault index according to another embodiment over frequency ranges 30-40 Hz, 60-80 Hz, and 95-110 Hz from (a) sensor 3 (driver's side) and (b) sensor 4 (passenger's side) for the vertical direction acceleration for front axle wheel crossing measured using long cleat with (1) all baseline datasets, (2) second order polynomial curve fit with 99% confidence bands, and (3) driver front 10 psi tire pressure.

FIG. 15: Fault index for various tire fault tests according to another embodiment with the tire fault in the (a) passenger front and (b) passenger rear tires indicating 90% confidence in diagnosis (fault cases for from left to right according to the legend shown in the figure in this and subsequent figures of this type).

FIG. 16: Fault index for various tire fault tests according to another embodiment with the tire fault in the (a) driver front and (b) driver rear tires indicating 90% confidence in diagnosis.

FIG. 17: Fault index for various suspension fault tests according to another embodiment with the suspension fault in the (a) passenger front and (b) driver rear suspension indicating 90% confidence in diagnosis.

FIG. 18: Fault index for various suspension fault tests according to another embodiment with the suspension fault in the (a) driver front and (b) passenger rear suspension indicating 90% confidence in diagnosis.

FIG. 19: Fault index according to another embodiment for various tests at 5, 7.5, and 10 mph nominal vehicle speed for no faults showing variability in fault index due to vehicle speed.

FIG. 20-1 is a schematic representation of an apparatus according to another embodiment of the present invention.

FIG. 20-2 is a schematic representation looking downward on an apparatus according to another embodiment of the present invention.

FIG. 20-3 is a schematic representation looking downward on an apparatus according to another embodiment of the present invention.

FIG. 21 is a schematic representation of a model of an apparatus according to one embodiment of the present invention.

FIG. 22 is graphical plot of a fault index according to another embodiment according to another embodiment of the present invention.

FIG. 23 shows a graphical user interface according to another embodiment of the present invention.

FIG. 24 shows the GUI of FIG. 23 when a fault is detected in a suspension component.

FIG. 25 shows the GUI of FIG. 23 when a tire fault is detected.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims.

The use of an N-series prefix for an element number (NXX.XX) refers to an element that is the same as the non-prefixed element (XX.XX), except as shown and described thereafter The usage of words indicating preference, such as “preferably,” refers to features and aspects that are present in at least one embodiment, but which are optional for some embodiments. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. This description convention also applies to the use of prime (′), double prime (″), and triple prime (′″) suffixed element numbers. Therefore, it is not necessary to describe the features of 20.1, 20.1′, 20.1″, and 20.1′″ that are the same, since these common features are apparent to persons of ordinary skill in the related field of technology.

Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

Incorporated herein by reference is U.S. patent application Ser. No. 61/098,995, filed Sep. 22, 2008, titled INSTRUMENTED CLEAT.

What will be shown and described herein, along with various embodiments of the present invention, is discussion of one or more tests that were performed. It is understood that such examples are by way of example only, and are not to be construed as being limitations on any embodiment of the present invention.

Current maintenance schedules for ground vehicles are determined based on reliability predictions (e.g., mean time to failure) of a population of vehicles under anticipated operational loads; however, vehicles that experience component damage often lie in the tails of the reliability distribution for a given platform. For example, a certain group of military vehicles may be deployed to operate on a harsh terrain that is particularly taxing on the mechanical components in the suspensions or frames in those vehicles. Operation & support costs for military weapon systems accounted for approximately ⅗^{th} of the $500B Department of Defense budget in 2006. In an effort to ensure readiness and decrease these costs for ground vehicle fleets, condition-monitoring technologies are being developed to enable maintenance decisions about individual vehicles.

Some embodiments of the present invention pertain to an apparatus that is an off-board vehicle damage detection system that can be used to enable CBM for a fleet of military wheeled vehicles. As an individual vehicle traverses a rubberized cleat, the cleat excites the vehicle dynamic response through an impulse delivered by the cleat to the wheels. The measured response of the cleat due to interactions between the wheel and a trailing edge plate aft of the cleat is then compared to a reference response to identify anomalies. The anomalies in the response are then used to detect, locate, and classify faults to enable CBM.

Dynamics-based condition monitoring is used because vibrations are a passive source of response data, which are global functions of the mechanical loading and properties of the vehicle. A common way of detecting faults in mechanical equipment, such as the suspension and chassis of a ground vehicle, that is used by many other researchers and companies is to compare measured operational vibrations with onboard sensors to a reference (or healthy) signature to detect anomalies. However, many vehicles are not equipped with sensors nor the acquisition systems to acquire, process, and store data; therefore, to implement condition monitoring, one must overcome the economic and technical barriers associated with equipping ground vehicles to continuously monitor the response.

Current maintenance schedules for ground vehicles determined based on reliability predictions of a population of vehicles under anticipated operational loads can lead to unnecessary maintenance and, in some cases, in-field failures depending on differences in the usage of individual vehicles. Condition-based maintenance is scheduled instead according to the condition of each vehicle to reduce the risk of failure and maintenance costs. However, on-board instrumentation for acquiring, processing, and storing operational data is expensive, and this data is also difficult to analyze due to variations in loading.

An instrumented diagnostic system for diagnosing mechanical faults in ground vehicle wheel ends and suspensions is shown and described in various embodiments of the present invention. A cleat 50 excites the vehicle's dynamic response through an impulse delivered to the vehicle's front and back tires. The response of an instrumented plate 56 is then recorded while in contact with the vehicle's tires using motion sensors 60. The measured dynamic response is compared to a reference response, and anomalies that correspond to vehicle faults are then detected.

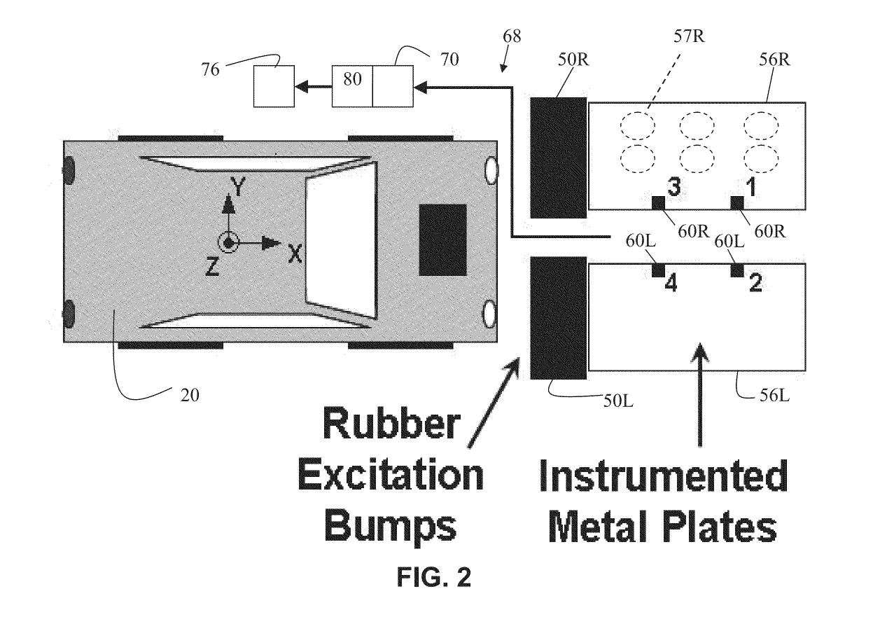

An instrumented diagnostic cleat is proposed in this work for fault identification as illustrated in FIG. 2. The dynamic response of the vehicle is measured using accelerometers attached to plates after the vehicle traverses the cleat at a given speed. The cleat introduces an impulsive base excitation to the wheels to produce a broadband response of the vehicle. The forces in the tires then act on the instrumented plates to register the response of the vehicle. Some aspects of methods according to some embodiments of the present invention include the following:
(1) A single diagnostic cleat and plate can diagnose faults in multiple vehicles reducing the cost per vehicle.
(2) The cleat geometry can be designed to control the amplitude and frequency of the base excitation imparted to the vehicle wheels allowing for targeted diagnostics.
(3) The vehicle speed can be controlled or estimated as it traverses the cleat to reduce variations in loading.
(4) Sensors are installed at the plate rather than the vehicle making it easier to maintain these sensors.
(5) Algorithms for analyzing response data from the cleat are less complex than for on-vehicle diagnostic algorithms.

Various embodiments of the present invention include correcting the measured response data, such as ignoring or modifying data pertaining to vehicle chassis modes of vibration in the frequency range below 10 Hz and natural frequencies in the free dynamic response of the cleat above 10 Hz. Tire and suspension faults are simulated in a high mobility multi-purpose wheeled vehicle and the faults are detected. Tire faults are simulated by decreasing the pressure within each tire below the manufacturer recommended level, whereas suspension faults are simulated by disconnecting each damper to mimic the effects of broken damper. The data indicates that the faults and locations of the faults are identified with 90% confidence in 7 out of 8 fault cases. Various other embodiments include correcting the measurements to compensate for changes in vehicle speed.

Various embodiments include a measurement and analysis system for diagnosing faults in the wheels and suspensions of a wheeled ground vehicle. Resilient cleats 50 were placed in front of two instrumented plates 56 to record the dynamic response of the vehicle 20 as it traversed the cleats. It is shown using modal impact testing together with complex mode indicator function analysis and operational mode analysis that resonance frequencies of the vehicle were dominant below 10 Hz while resonance frequencies of the plates were dominant above 10 Hz. It was also shown that the boundary conditions of the two plates, which were rested on elastomeric pads 57, were somewhat different leading to differences in the X, Y, and Z directional acceleration measurements on the two plates.

Tire faults and suspension faults were both simulated in the vehicle, and these faults were detected and located with 90% confidence. A relatively simple fault index including the integral of the discrete Fourier transform was used to perform the diagnostic analysis. Variations in the fault index were observed due to changes in vehicle speed, but these variations could be reduced by estimating the vehicle speed and then utilizing this estimate to adjust the fault index accordingly. Broad frequency ranges were selected to provide more robust and less sensitive diagnostic performance.

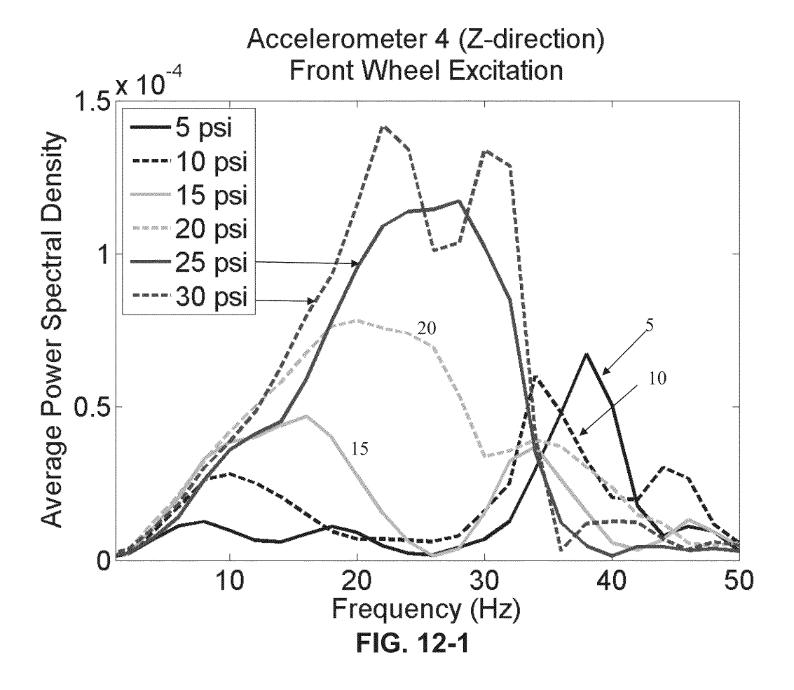

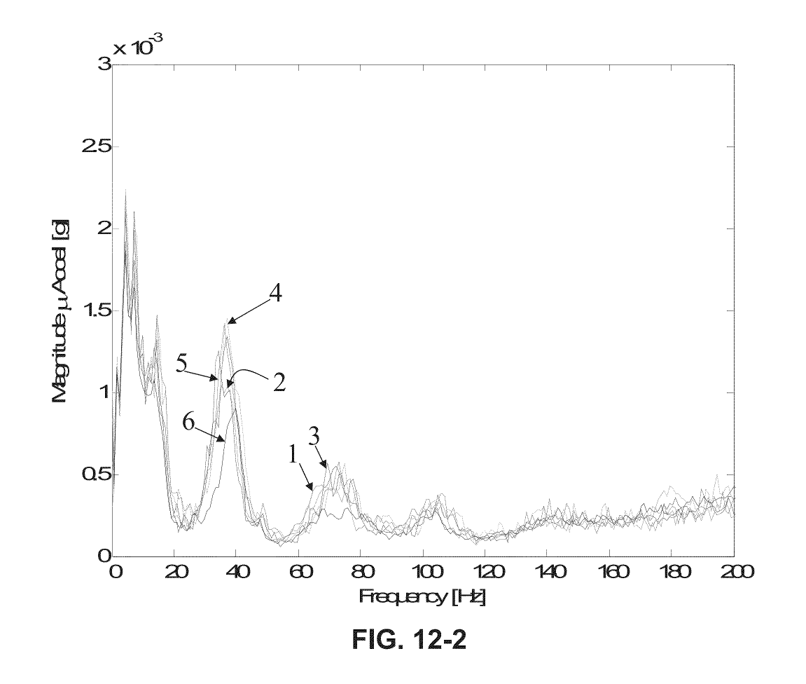

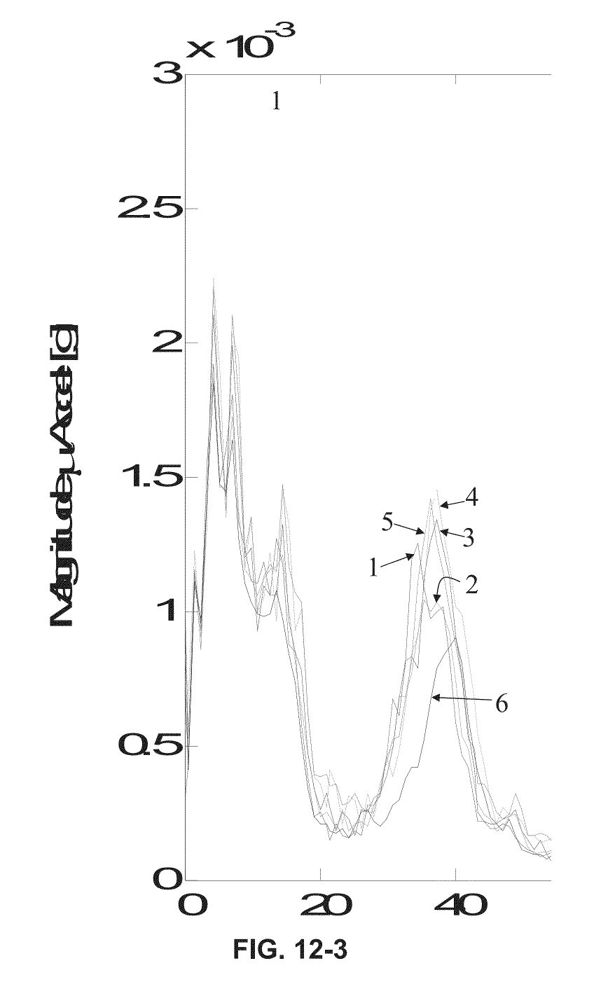

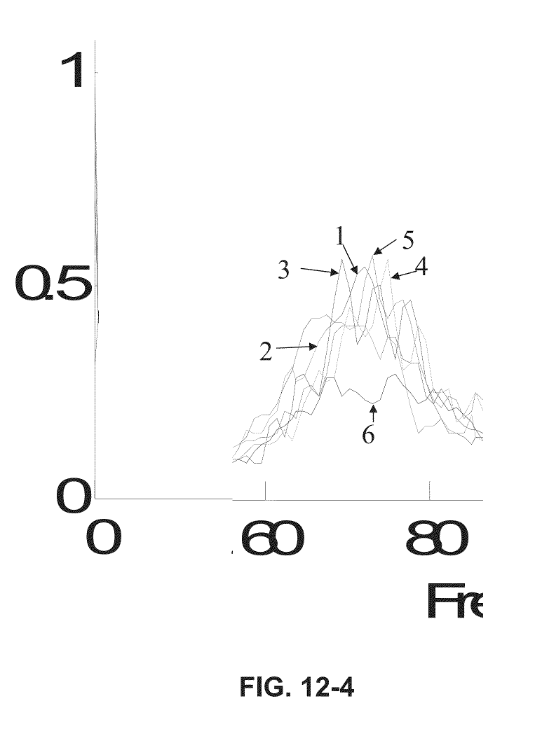

The diagnostic capability due to tire faults in the form of reductions in tire air pressure was examined using the cleat and plate system 68. The prescribed healthy front and rear tire pressures were 20 and 22 psi, respectively. To simulate a tire fault in one tire at a time, the air pressure in the tire of interest was reduced to 10 psi. Thirty datasets were then acquired for the faulty tire condition. A comparison of the mean baseline datasets and the datasets for the driver front faulty tire were plotted in FIGS. 12-2, -3 and -4 for the vertical response measured by sensor 3 on the extended diagnostic speed bump. It was evident that the largest percent change in the responses due to the tire fault occurred in the frequency ranges 30-40 Hz, 60-80 Hz, and 95-110 Hz.

The instrumented diagnostic cleat in some embodiments includes two rubber cleats 50 (or changes in elevation), or speed bumps, that are placed in front of two instrumented plates 56. The two rubber cleats 50 are spaced 0.91 m apart to align the center of the rubber cleats 50 with the center of the HMMWV tires on each side of the vehicle. The rubber cleats are preferably each held in place with four bolts, in some embodiments of the present invention. However, it understood that in yet other embodiments the cleats 50 are not attached to the surface of roadway 22.

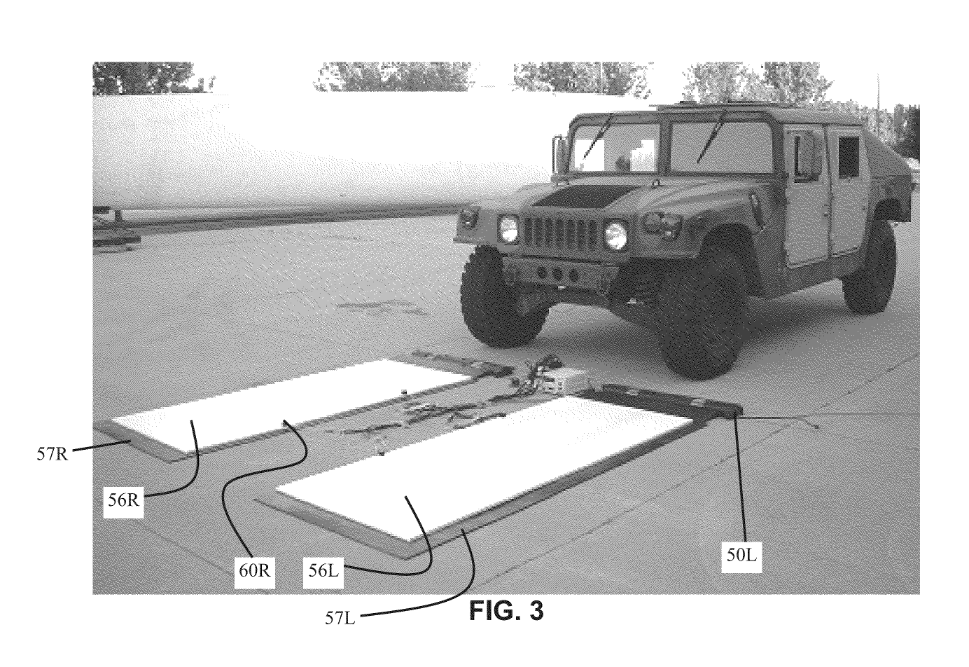

FIG. 3 is a photograph of the test setup along with a HMMWV vehicle about to traverse the extended diagnostic speed bump 50. Four sensors, two sensors 60R on the right side and two sensors 60L on the left side, were attached to two aluminum plates 56R and 56L, respectively, which were 85 inches long and ½ inch thick. Aluminum was selected to avoid excessive deformation due to the dynamic weight of the vehicle—excessive deformation of the plate would result in filtered of the response measurement. The plates were placed on a thin rubber sheet 57 on the roadway immediately behind the rubberized speed bump underneath the tracking lanes of the left and right wheels of the vehicle. The rubber sheet was used to correct for small differences in elevation of the roadway surface. Sensors 1 and 2 were placed 60 inches behind the speed bump whereas sensors 3 and 4 were placed 30 inches behind the speed bump. Four sensors were used so that the effects of sensor position could be studied. Triaxial accelerometers (PCB 356B18) were used so that the effects of measurement direction (vertical, tracking, and lateral) on diagnostic capability could be studied. FIG. 3 shows the attachment of the sensors to a National Instruments NI cDAQ-9178 compact eight slot data acquisition chassis with NI 9234 data acquisition cards.

Each metal plate 56 is 2.1 m long, 0.91 m wide, and 1.27 cm thick. The plate thickness was chosen to withstand a point load force equivalent to the force exerted on the plate by the HMMWV's tires without any plastic deformation to prevent the possibility of the plates warping or deforming during testing. Also, the plate length is preferably the length that permits one tire at a time to be in contact with the plate. In some embodiments, the plates have a length that is less than about the wheelbase of the vehicle being tested (the wheel base being the distance from the centerline of a front wheel to the centerline of a rear wheel). It is preferred that the front tire be out of contact with the plate 56 before the rear tire comes into contact with plate 56. Further, it is preferred that the plates have a length that is at least as long as the circumference of a tire.

It is preferred that plates 56 be fabricated from a material that is stiff, such as steel or aluminum. However, the present invention is not constrained to metallic plates, and includes plates fabricated from any material. Preferably, the plate material, and further the geometry of the plate (including length, width, and thickness) be selected such that the primary vibratory responses of the plate are sufficiently high so as to not interfere with the collection of the plate's forced response from contact with the tires.

The metal plates are preferably supported on rubber elastomeric pads 57 to isolate the plates from extraneous ground vibrations. Each resilient pad 57 is 2.2 m long, 1.0 m wide, and 5.0 cm thick. The metal plates are preferably not restrained or attached to the pads in any way. As shown in FIG. 3, each pad 57 is about the same length and width as the plate 56. FIG. 2 shows an alternative resilient support 57R which includes a plurality of individual rubber pads that support a plate from the roadway. It is preferred that the pads 57 be attached to plates 56 for ease of shipping, storage, and installation, but various embodiments envision resilient pads 57 that are separate from plates 56. Still further embodiments contemplate the use of means for isolating the plates from the roadway, wherein the means includes pads similar to those shown in FIG. 3, supports similar to those shown in FIG. 2, or any manner of substantially isolating the plate from vibrations of the roadway.

The metal plates 56 are instrumented with four (1000 mV/g) tri-axial accelerometers 60. Two accelerometers are preferably installed on each plate along the inner edge of the plate closest to the center of the vehicle. The two accelerometers 60 are installed 0.76 m and 1.5 m away from the rubber FIG. on each plate. The accelerometers 60 are mounted with super glue and given a minimum of two hours to cure before testing. The accelerometers 60 are numbered as shown in FIG. 2. Accelerometers 1 and 3 are located on the driver's side plate, and accelerometers 2 and 4 are located on the passenger's side plate in which accelerometer 2 was the accelerometer furthest from the excitation bump. The directions of the accelerometers align to the global coordinate system of the vehicle as shown in FIG. 2. The accelerometers are connected through microdot cables to multiple data acquisition cards, which are loaded into a chassis. The chassis is connected to a laptop computer using a USB cable. The chassis is controlled through user-defined software. The data acquisition system is triggered automatically to start acquiring data when the vehicle comes into contact with the metal plates causing one of the accelerometers to respond above the set trigger threshold level. The data acquisition system collects 12 channels of data after being triggered.

Although reference has been made to the use of accelerometers 60 for the generation of signals corresponding to vibratory motion of the plates in terms of acceleration, it is understood that yet other embodiments of the present invention are not so constrained. Yet other embodiments contemplate the use of motion sensors 60 that provide output signals corresponding to any type of movement of the plate, including displacement, velocity, acceleration, or further time derivatives. Further, although reference has been made to the use of tri-axial accelerometers, it is understood that the motion sensors 50 can be single or dual dimensional in terms of response, and further that each plate can have a mixture of motion sensors, some which are uni-axial, others of which are tri-axial, some of which measure acceleration, and others of which measure displacement, as examples.

FIG. 2 further includes a schematic representation of a system for analyzing the response of the vehicle. System 68 includes at least one roadway elevational change 50 (which can be a rise or a dip), followed by a measurement section in which the response of the vehicle tires on a platform (such as plate 56) is measured by at least one motion sensor. Data from the sensor is provided to a computer 70 that includes software 80 for analyzing the data and providing information related to the condition of the vehicle. Preferably, system 68 includes a display 76 having a graphical user interface 78 that displays some of the information to the operator, and preferably further indicates whether or not the vehicle has any faults, or needs any maintenance.

The measured data is segmented into two parts corresponding to the response of the plates while the front tires are in contact with the plates and while the rear tires are in contact with the plates. If a vehicle travels at 5 mph, one of the tires is in contact with the instrumented plates for 0.97 sec resulting in a 1.03 Hz frequency resolution in the spectra. In various embodiments of the present invention the software of computer 70 includes an algorithm for separating front wheel response from rear wheel response. In some embodiments, this algorithm includes calculation of vehicle velocity based on the timing of impacts to a plate 56, whereas in other embodiments the algorithm looks at the nature of the time response, with the response of the plates to the front tires diminishing as tires roll toward the front edge of a plate and the response of the plate to the rear tire being substantially larger in magnitude as the rear tire leaves the cleat 50 and first rolls onto plate 56.

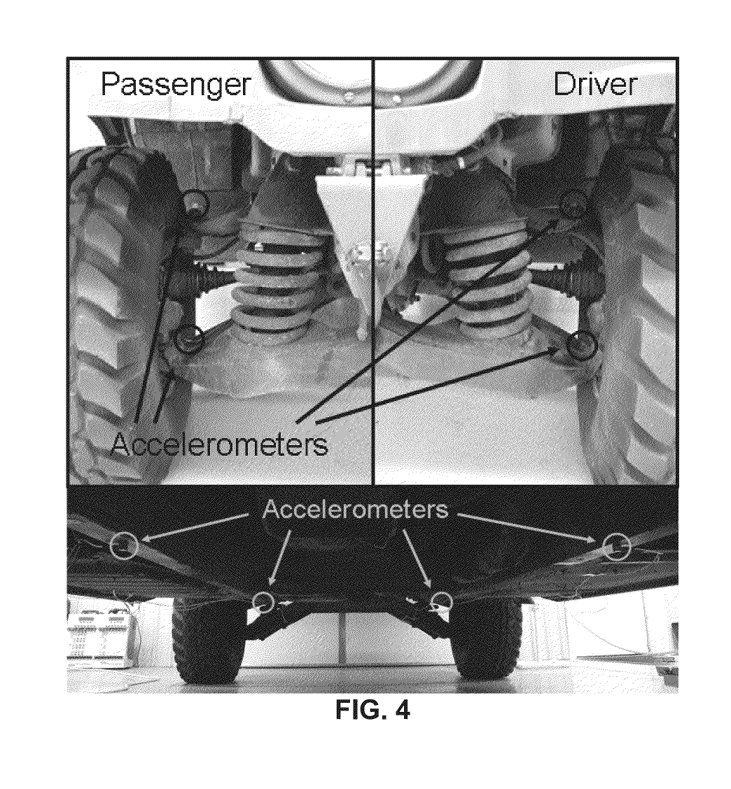

The vehicle is instrumented with sensors in order to better understand how the diagnostic cleat is responding, with and without faults present in the vehicle. The onboard sensors are not required to implement the instrumented diagnostic cleat for fault detection. The HMMWV is instrumented with two (100 mV/g tri-axial) accelerometers and ten (100 mV/g) single axis accelerometers. The two tri-axial accelerometers are installed on the upper and lower control arms as close as possible to the ball joint for the passenger front suspension. Likewise, two single axis accelerometers are installed on the upper and lower control arms as close as possible to the ball joint for each of the driver front, driver rear, and passenger rear suspensions as shown in FIG. 4(a) for the passenger front and driver front suspensions. The remaining four single axis accelerometers are installed on the four corners of the HMMWV's frame on the undercarriage of the vehicle as shown in FIG. 4(b). All accelerometers are attached to the vehicle using super glue. The directions of the tri-axial accelerometers align to the vehicle's global coordinate system and the single axis accelerometers align to the vertical direction.

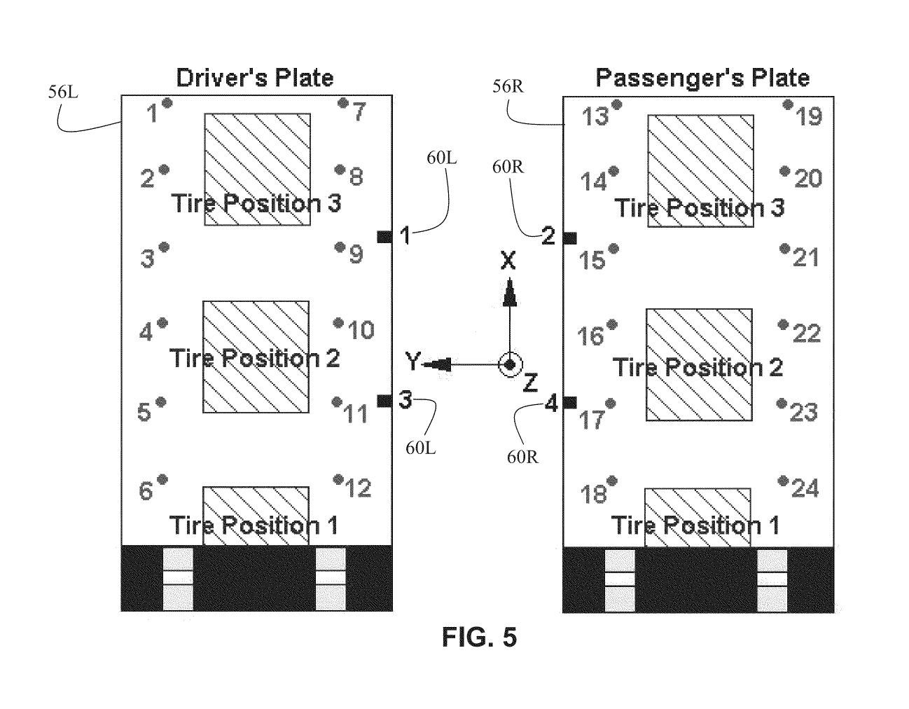

Modal impact testing was conducted on the instrumented metal plates in order to determine how the free response of the plates influences the measurements when the vehicle is driven over the diagnostic cleat. It was believed that resonance frequencies of the plates would include responses when the vehicle was driven over the cleat. The response of each plate is measured using four tri-axial accelerometers as previously mentioned. A mini sledge impact hammer instrumented with a load cell is used to apply an impulsive force at various locations on the plate as illustrated in FIG. 5. The data acquisition system is setup to collect three seconds of data at a sample rate of 2048 samples per second. Each plate is impacted at twelve locations. The twelve impact locations result in a 2-by-6 grid of input degrees of freedom. Each impact location is impacted 5 times with the modal hammer to collect 5 measurements for averaging.

The plates are impacted while the vehicle 20 front tires are resting on the plates in three locations. The three tire positions correspond to the center of the HMMWV's front tires resting on the metal plates at 0, 0.89, and 1.78 m from the rubber cleats. In yet other embodiments, the baseline response at the plate is measured with a static load applied on the plate, and including those embodiments in which the static weight is representative of the weight supported by a wheel of a vehicle. Further, it is anticipated that this response spectrum of the loaded plate 56 can be a function of weight, such that the correction applied to the responses made during testing of a vehicle include modifying the correction for the weight of the vehicle. In some embodiments, the plate modal response spectrum (which can subsequently be used to correct motion data during vehicle testing) is prepared with a simple application of load to the surface of the plate, whereas in other embodiments the load is transferred into the plate through a resilient interface, such as an elastomeric interface.

The auto power spectra for the average force at each impact location exhibited a 1 dB rolloff by approximately 400 Hz. Frequency response functions between the input forces and the acceleration responses are estimated using the H1 estimator. These functions are valid between 1 and 400 Hz due to the rolloff of the modal impact forces. The analysis that is described here is limited to the frequency range from 1 to 100 Hz. However, it is understood that other embodiments of the present invention are not so constrained, and include frequency response functions not limited to any particular frequency range.

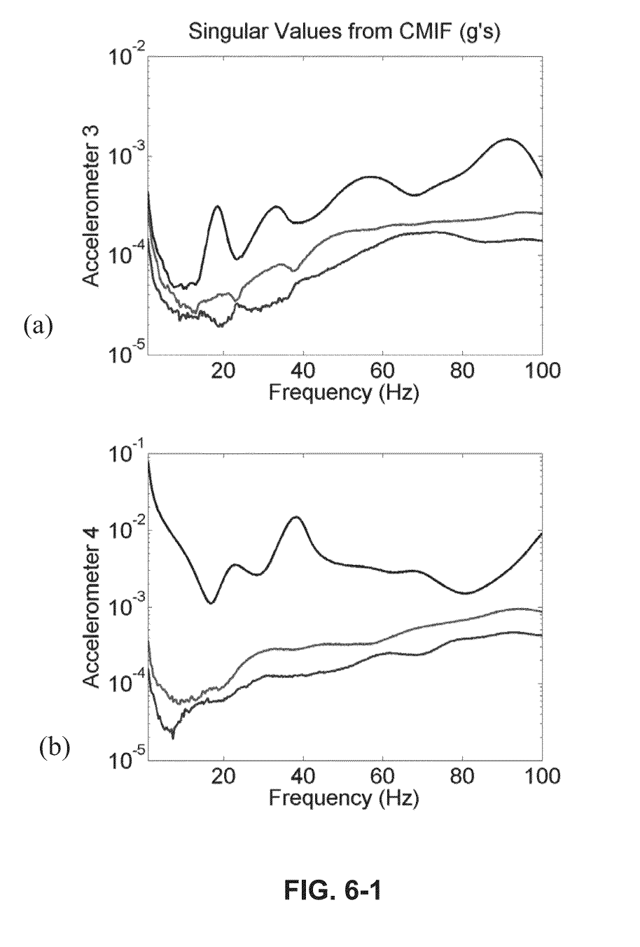

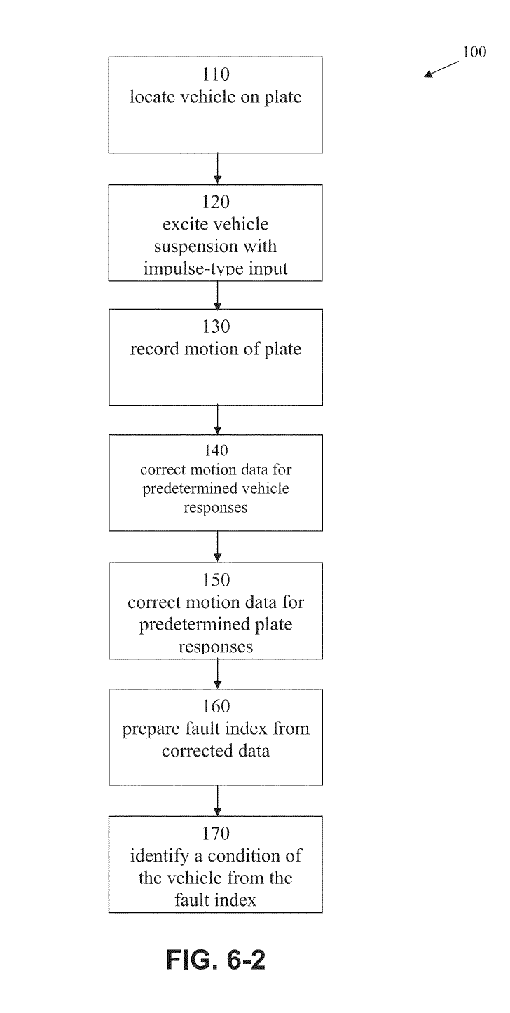

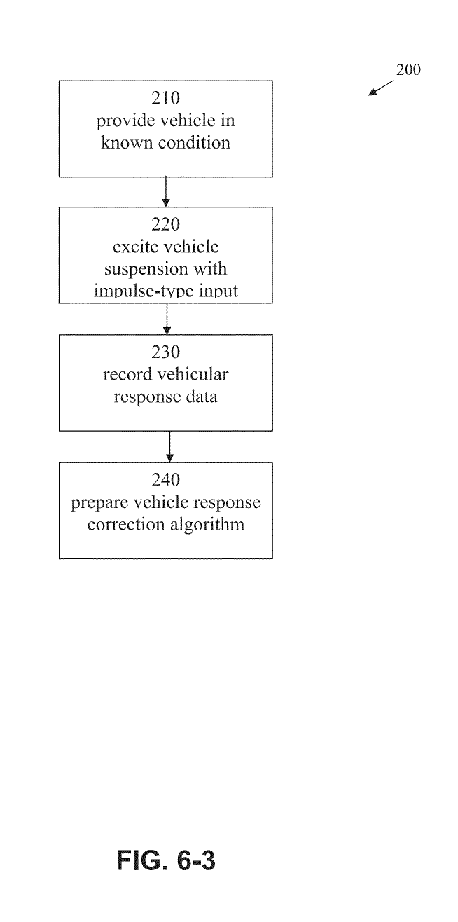

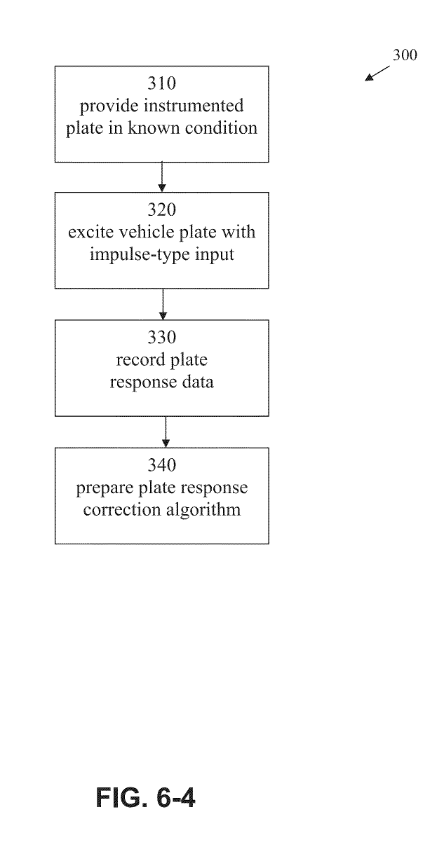

The complex mode indicator function (CMIF) is used here to identify the modes of vibration that comprise the measured frequency response functions of the driver and passenger side plates of the diagnostic cleat. The CMIF calculates the singular value decomposition of the frequency response function matrix as expressed below:

[H(ω)]=[U(ω)][Σ(ω)][V(ω)]^{H} (1)

where [H(ω)] is the frequency response function matrix with Nₒ rows and Nᵢ columns (with Nₒ equal to the number of response measurements, 3, and Nᵢ is the number of modal impacts, 12, on each plate), [U(ω)] is the left singular vector matrix, [Σ(ω)] is the singular value matrix, and [V(ω)] is the right singular vector matrix. The CMIF used in some embodiments is a plot of the singular values of the imaginary part of the frequency response function matrix versus frequency, and the peaks in these singular value curves denote the resonance frequencies. FIG. 6(a) shows the three singular values for the driver's side plate and FIG. 6(b) shows the three singular values for the passenger's side plate.

These plots reveal that there are peaks in vibration of the driver's side plate at 19, 34, 57, and 92 Hz and peaks in vibration of the passenger's side plate at 23, 38, 57 (heavily damped), and 68 Hz. The passenger side plate has a much larger CMIF magnitude, which is also reflected in the measurements of the plate forced response. The differences in the two plate modes of vibration are due to the boundary conditions provided by the roadway and the elastomeric pads.

The vehicle 20 is driven over the diagnostic cleat 50 and plate 56 multiple times at 5 mph in order to acquire measurements for analyzing the response of the vehicle. The speed of the vehicle is controlled by the driver with the speedometer gauge. The tire pressure is set to a recommended tire pressure, which is inscribed on each tire. The recommended tire pressures are 20 psi for the front wheels and 22 psi for the rear wheels. The data collected in this experiment was collected within one day with one driver to minimize the variability due to the weather and the driver. The data acquisition system is set to collect 4.5 sec of data from the vehicle sensors at a sample rate of 2048 samples per second. Although what has been shown and described is a method in which the vehicle is driven multiple times over the cleat on one day with a particular driver, it is understood that the invention is not so constrained, and includes those embodiments in which data is recorded and analyzed from a single traversing of the vehicle over the cleat and plate, and further without limitation as to when the data is collected or who is driving the vehicle.

FIG. 6-2 shows a method 100 of analyzing data from a vehicle according to one embodiment of the present invention Method 100 includes locating 110 of the vehicle 20 on an instrumented plate 56. Preferably, the vehicle 50 is located on plate 56 by driving the vehicle onto the plate. However, the present invention also includes those embodiments in which the front wheels of the vehicle are located on individual right and left plates 56R and 56L, respectively, and after being placed on these plates the plates are excited with an impulse-type input. In some embodiments this input can be provided by an electric actuator or hydraulic cylinder.

Method 100 further includes exciting 120 of the vehicle with an impulse-type input. As previously described, in some embodiments this input can be provided by electrical or hydraulic actuation means. However, preferably, the excitation 120 of the vehicle 20 is provided by driving the vehicle over a change in roadway elevation, which can be a dip or a bump. Preferably, the change in elevation is a cleat 50. Further, in yet other embodiments, the locating 110 of the vehicle is performed by driving the vehicle onto the plate after having driven the vehicle over the cleat 50.

Method 100 further includes recording 130 the motion of the plate. The motion can be measured with any means for measuring motion, including as examples, a laser velocimeter, piezoelectric accelerometers, or displacement transducers. Preferably, the motion is measured using an accelerometer 60 coupled to plate 56. The motion of the plate is recorded while the vehicle is still responding to the input provided by excitation 120.

The recorded motion data includes correction 140 the motion data for predetermined vehicle responses. This correction can be in any format, including the time domain or frequency domain. Further, in some embodiments the data is corrected in the order domain, which is preferably established by the length of time for a tire to traverse plate 56 from one end to the other end. Preferably, the plate has a length that is less than the wheelbase of the vehicle, so that only one tire is on a plate at any particular moment. Algorithms for correcting the motion data are described further in method 200 and shown in FIG. 6-3.

The recorded motion data includes correction 150 the motion data for predetermined plate responses. This correction can be in any format, including the time domain or frequency domain. Further, in some embodiments the data is corrected in the order domain, which is established by the length of time for a tire to traverse plate 56 from one end to the other end. Preferably, the plate has a length that is less than the wheel base of the plate, so that only one tire is on a plate at any particular moment. The algorithm for correcting the motion data is described further in method 300 and shown in FIG. 6-4.

Method 100 further includes preparing 160 a fault index from the corrected data. This fault index can be prepared in any of the time, frequency, or order domains. Further, the fault index can be of any type.

Method 100 further includes identifying 170 a condition of the vehicle from the fault index. The condition is preferably identified by comparing the fault index to a historical and/or predetermined database. As one example, a predetermined database can include a range of fault indices that correspond to a known fault that was induced in a vehicle during a test. As another example, a historic database can include responses from this same vehicle, or from vehicles of similar type, measured over a period of time.

FIG. 6-3 shows a method 200 according to another embodiment of the present invention. Method 200 is preferably performed prior to the performance of method 100. In some embodiments, the algorithm produced by method 200 is useful in the act 140 of method 100, which relates to the correction of plate response data. However, it is also appreciated that method 200 is further useful in act 160, which pertains to preparation of a fault index from the plate response data.

Method 200 includes the act 210 of providing a vehicle in a known condition. This known condition can be a vehicle with no known faults, or can be a vehicle with one or more faults either purposefully introduced into the vehicle or arising from use or improper manufacture of the vehicle. In some embodiments, the vehicle is a new vehicle that is in the final stages of assembly by an OEM. In yet other embodiments, the vehicle is in the final stages of preparation at a repair depot or garage.

Method 200 further includes the act 200 of exciting the vehicle with an impulse-type input. As noted in method 100, this input can be provided by actuating means, or provided by driving the vehicle over an elevational change. The input used with act 220 is similar to the input provided by act 120 of method 100.

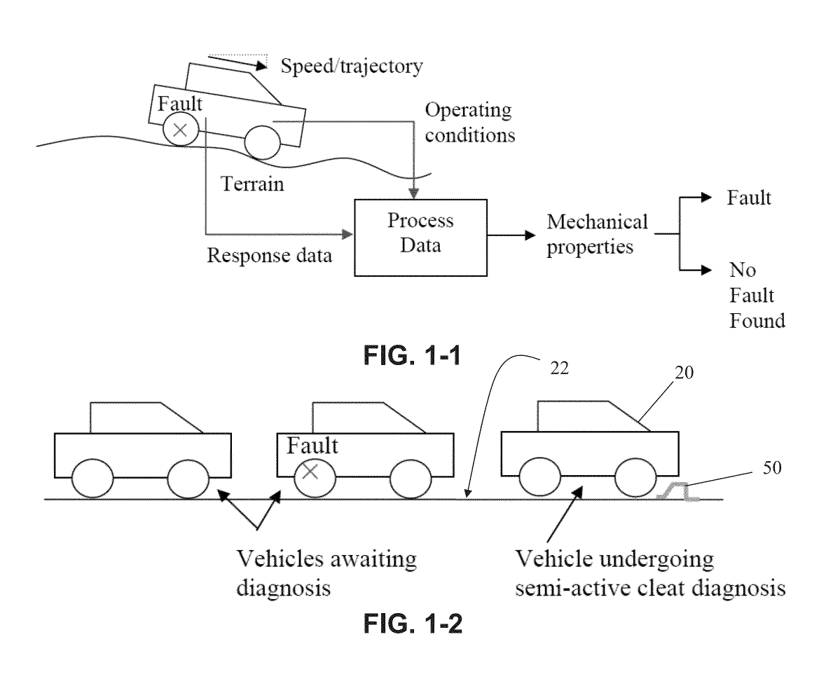

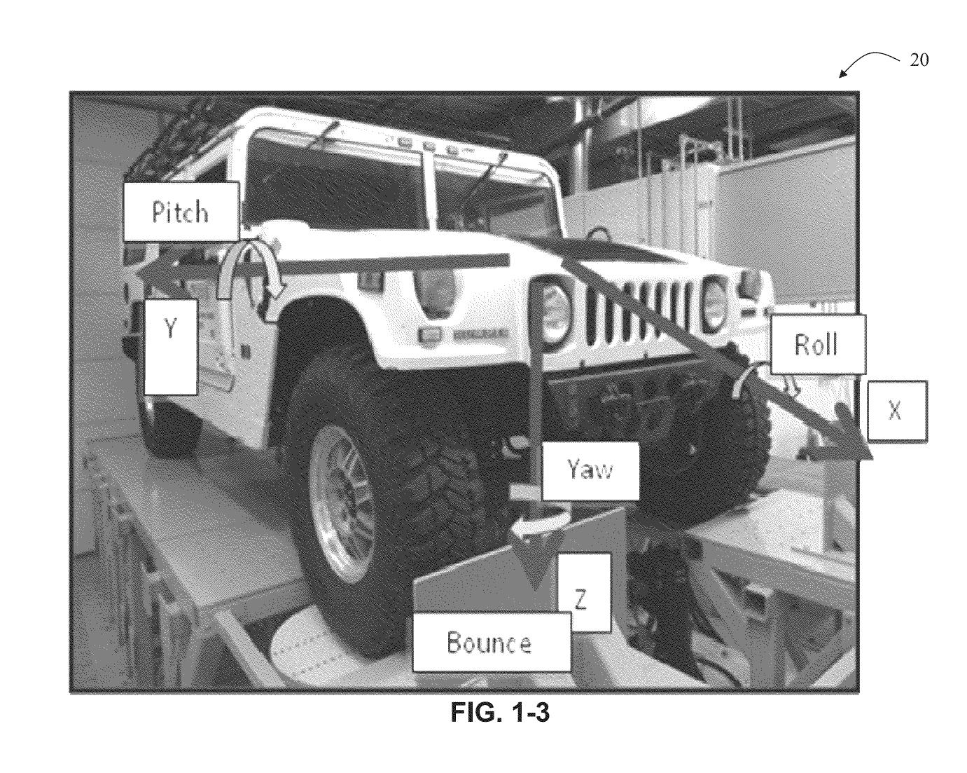

Method 200 further includes the act 230 of recording the vehicle response data. Subsequently, method 200 preferably includes the act 240 of preparing a correction algorithm that is applied to the motion data in method 100 to minimize the influence of vehicle responses, including rigid body vehicle responses such as rolling, pitching, and jounce and rebound (vertical translation). In one particular vehicle as shown in FIG. 1-3. the vehicular body modes are as shown in Table 1:

TABLE 1
Vehicle Properties

| | Two-post shaker testing |
|---|---|
| Vehicle mode | Frequency (Hz) |
| Roll | 1.8 |
| Bounce | 2 |
| Pitch | 4.1 |
| Wheel hop | 9 |
| Beaming | 11.4 |
| Torsional shake | 11.9 |

This correction algorithm can be of any type that minimizes the effect of standard or routine vehicle responses from the plate motion data, yet does not eliminate or significantly minimize the plate response data indicative of vehicle faults. In some embodiments, the algorithm is a simple low frequency cutoff. In yet other embodiments the algorithm includes a high pass filter intended to roll-off the lower, rigid body modes of vehicle vibration. In yet other embodiments the algorithm includes truncation of the plate motion data in the time domain. Still further examples are provided herein. In still other embodiments, the motion data is presented to the system user, and the user is instructed as to what time periods or frequency bans to ignore or de-emphasize.

FIG. 6-4 shows a method 300 according to another embodiment of the present invention. Method 300 is preferably performed prior to the performance of method 100. In some embodiments, the algorithm produced by method 300 is useful in the act 150 of method 100, which relates to the correction of plate response data. However, it is also appreciated that method 300 is further useful in act 160, which pertains to preparation of a fault index from the plate response data.

Method 300 includes the act 310 of providing a plate in a known condition. This known condition can be a plate with no known faults, or can be a plate with one or more faults either purposeful introduced into the plate or arising from use or improper manufacture of the plate. In some embodiments, the plate is a new plate that is in the final stages of assembly by an OEM. In yet other embodiments, the plate is in the final stages of preparation at a repair depot or garage.

Method 300 further includes the act 320 of exciting the plate with an impulse-type input, such as a hammer as used in modal testing. It is further preferred that the plate be supported on a resilient isolator 57. Still further, in some embodiments the plate modal data is acquired when the plate is loaded statically, as by a tire of a vehicle to be tested.

Method 300 further includes the act 330 of recording the plate response data. Subsequently, method 300 preferably includes the act 340 of preparing a correction algorithm that is applied to the motion data in method 100 to minimize the influence of plate modal responses from the plate response taken during vehicle testing. This correction algorithm can be of any type that minimizes the effect of standard or routine plate responses from the plate motion data, yet does not eliminate or significantly minimize the plate response data indicative of vehicle faults. In some embodiments, the algorithm is a simple high frequency cutoff. In yet other embodiments the algorithm includes a low pass filter intended to roll-off the higher modes of plate vibration. In yet other embodiments the algorithm includes truncation of the plate motion data in the time domain. Still further examples are provided herein. In still other embodiments, the motion data is presented to the system user, and the user is instructed as to what time periods or frequency bans to ignore or de-emphasize.

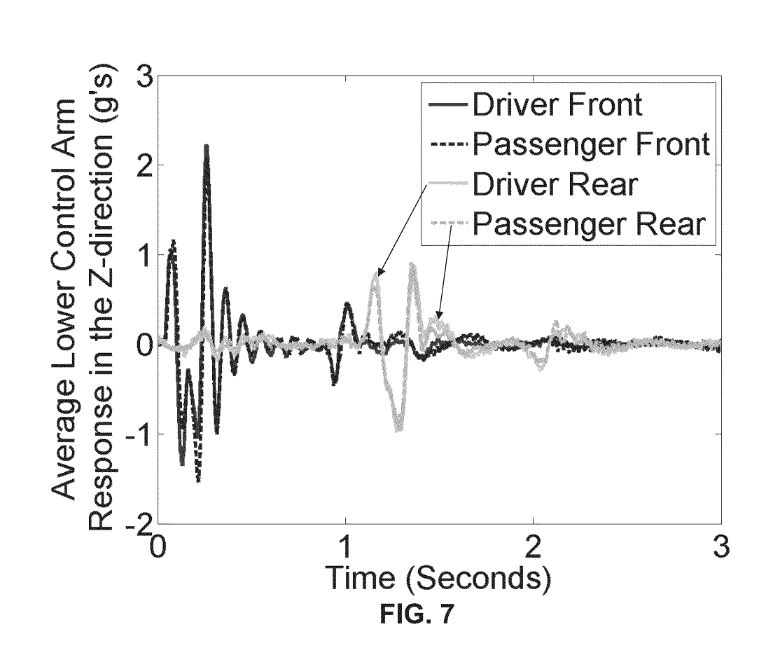

The average measured responses from the accelerometers that are mounted on the lower control arms are plotted in FIG. 7. The driver's side average response measurements are nearly identical to the passenger's side response measurements. This result suggested that there is symmetry with respect to the longitudinal axis of the vehicle. However, the responses of the front lower control arms are different than the responses of the rear lower control arms implying there are differences in the effective mass and stiffness against which the lower control arms are pushing in the front and rear suspensions. The effective masses of the front and rear suspensions are different because the engine is located in the front of the vehicle and the vehicle had no payload resulting in the front suspension supporting more of the vehicle's mass than the rear suspension.

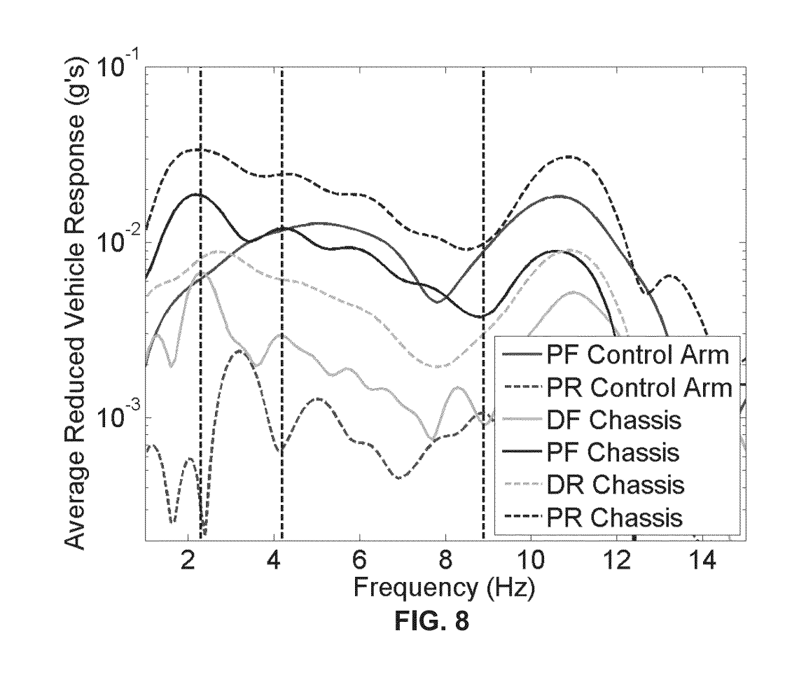

In order to avoid minimize the vehicle response spectra that are created by the successive excitations by the front and rear wheels, the measured time response in FIG. 7 is reduced to 1.2 seconds, which contains primarily the response of the vehicle as the front wheels traverse over the cleat. Then the shortened response is zero padded out to 10 seconds to maintain an adequate frequency resolution. The scaled discrete Fourier transform (DFT) of the shortened response is determined for each data channel. The magnitude of the scaled DFT in the Z-direction for the chassis accelerometers and the passenger front and passenger rear lower control arm accelerometers are plotted in FIG. 8. The approximate natural frequencies of the vehicle are marked using dashed lines. The natural frequencies and rigid body modes of the vehicle include bounce, pitch, and roll, which are highly coupled.

The modes of vibration of the vehicle are estimated by analyzing the operational deflection shapes. An operational deflection shape is defined as the dynamic deflection of the vehicle under the front wheel excitation at a particular frequency. The operational deflection shapes are a weighted sum of the modes of vibration of the vehicle. Unlike the modal deflection shapes, the operational deflection shapes are dependent on the excitations; for example, if the data for a rear wheel crossing is instead analyzed, the shapes are somewhat different than those described here. Unlike a frequency response function, which is calculated by measuring both the excitation and response of the vehicle as in the modal impact tests, the operational data used in some embodiments includes the vehicle response measurements.

The operational deflection shapes of the vehicle are determined with the operational deflection shape frequency response function, or ODS FRF, which is calculated using response data acquired during the front wheel crossing of the cleat,

$$ODSFRF ( ω ) = \sqrt{{G}_{XX} ( ω )} \frac{{G}_{XY} ( ω )}{‖ {G}_{XY} ( ω ) ‖} \qquad ( 2 )$$

where G_{XX}(ω) is the auto power spectrum of the measured response variable and G_{XY}(ω) is the cross power spectra between the measured response and the reference measurement. The reference is one of the measured responses. The ODS FRF determines the magnitude and phase of the deflection at each measurement location and the ODS FRFs have peaks at natural frequencies of the system. A vehicle measurement grid is constructed that graphically represents the location of each accelerometer that is used. Then the product of the magnitude and phase of the ODS FRF at a specific frequency for each accelerometer is represented on this grid to visualize the operational deflection shapes at that frequency.

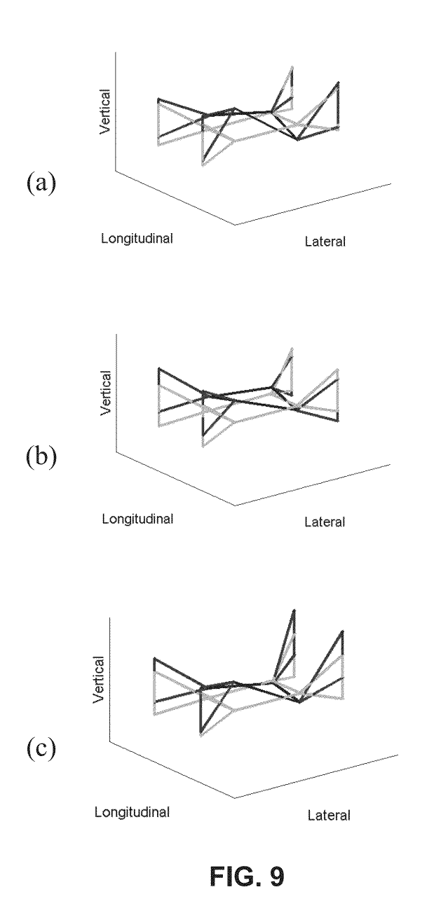

Using this technique, the modes of the vehicle are identified by studying the animations of the operational deflection shapes. The ODS results at the peaks indicated in FIG. 8 are plotted in FIG. 9(a,b,c) for each accelerometer in the Z-direction using the X-direction of the accelerometer on the upper control arm of the passenger front suspension as the reference measurement. The static vehicle grid is drawn with light gray lines and the deflection shapes for the suspension and chassis are drawn with gray and black lines, respectively. It is determined that the pitch mode occurs at approximately 4.2 Hz, bounce occurs at approximately 2.3 Hz, and wheel hop occurs at approximately 8.9 Hz. These peaks can be seen in FIG. 9. The vehicle actually possesses two bounce modes because of the difference in stiffness between the front and rear suspensions. The bounce mode at approximately 2.3 Hz corresponds to the bounce of the front of the vehicle. The bounce mode for the rear of the vehicle is found to occur at approximately 3.6 Hz, which is relatively high for this type of vehicle because it is tested without any payload.

The instrumented diagnostic cleat plates exhibit resonance frequencies above 10 Hz and the vehicle chassis and suspension exhibit resonance frequencies below 10 Hz. Experimental data can be used to understand the accelerometer responses of the two plates in the diagnostic cleat. The HMMWV (without faults) is driven over the diagnostic cleat 50 times at 5 mph. 2.28 seconds of data are sampled at 3200 samples per second, and the measured response is divided into two equally sized segments of length 1.14 seconds, which span the response due to the front wheel excitation and the response to the rear wheel excitation, respectively. The scaled DFT of the measured responses due to a front wheel excitation and rear wheel excitation are then calculated for each accelerometer in each direction.

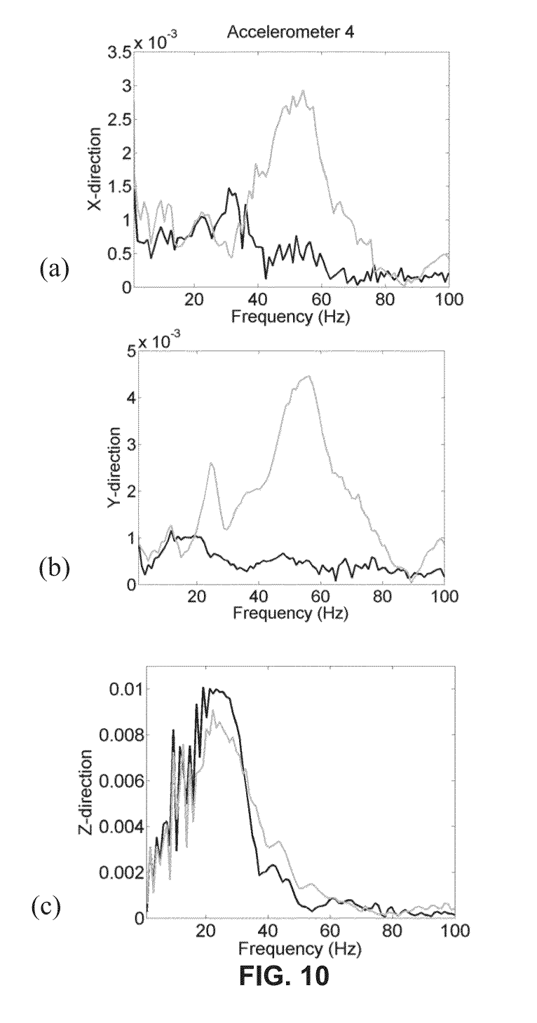

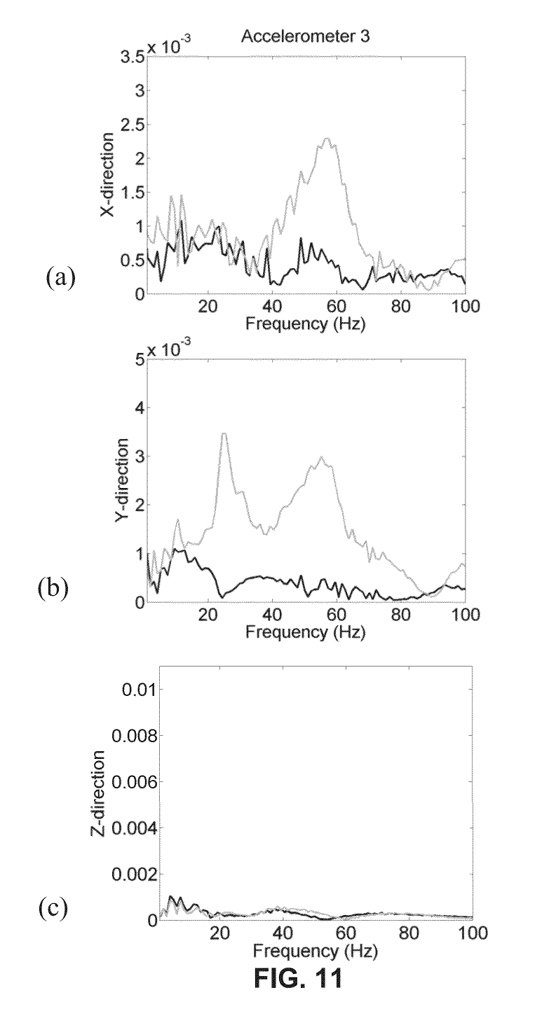

The magnitude of the average scaled DFT for the front and rear wheel excitations for accelerometer 4 on the passenger side plate in the X, Y, and Z directions are plotted in FIGS. 10 (a), (b), and (c), respectively. The corresponding plots for accelerometer 3 on the driver side plate are shown in FIGS. 11 (a), (b), and (c). The measured responses from the accelerometers for the front wheel excitations (dark lines) are similar for the driver and passenger side plates in the X and Y directions. The rear wheel excitations also produce similar responses in the X and Y directions. However, the rear wheel excitation produces larger responses in general than the front wheel excitation due to the stiffer rear suspension and the additive effects of the front and rear wheel inputs.

Both plates exhibit peaks in the X and Y directions at approximately 55 Hz for the front wheel excitation case. For the rear wheel excitation case, the responses of both plates display peaks at 57 Hz, which is a natural frequency of the driver's side plate. In the Y direction, both plates also display peaks near 20 Hz, which is also close to a natural frequency of both plates. The measured response of the driver's side and passenger's side plates may be similar in the X direction because X corresponds to the forward direction of the vehicle. Based on these results for the X and Y directions, it is also evident that the vehicle modes of vibration dominate the response of the plates at low frequency below 10 Hz, which can be seen in the plots in FIG. 10(a,b) and FIG. 11(a,b), while the plate modes of vibration dominate the response of the plates above 10 Hz.

One difference in the data for the driver and passenger side plates occurs in the Z direction (vertical). The passenger side plate response was larger than the driver side plate response. This difference in the amplitude of response is attributed to differences in the boundary condition on the elastomeric pad on which the plate rests. The responses corresponding to the front and rear wheel excitations are similar for the Z direction on both plates. In some embodiments, the corrections applied to the data measured from sensors 56 can be different as applied to one side of the vehicle versus the other side of the vehicle. In some cases, the corrections applied can be different based on the plate response data (such as the data from sensor 56 recorded at higher frequencies). Further, the fault index applied to the right side or left side can differ from one another based on the measured responses of the plates.

Tire faults were simulated in the vehicle by decreasing the air pressure. This method of simulating faults in the tire leads to changes in the tire stiffness and damping by changing the degree to which the air and sidewall contribute to the forces supplied by the tire patch. The HMMWV that is used for testing simulated tire faults as four tires whose maximum tire pressure is 30 psi. These tires are also runflats that can operated at 0 psi because a belt within the tire prevents the vehicle from riding on the wheel rim when the tire pressure goes to zero. The pressure within the tires is set to a value between 0 psi and 30 psi. The tire pressure fluctuates somewhat around the set pressure during testing by ±1 psi due to temperature changes within the tire and the ambient environment. The assumed nominal tire pressures are 20 psi for the front wheels and 22 psi for the rear wheels.

To conduct the first set of tire fault tests, the tire pressure is set to 5, 10, 15, 20, 25, and 30 psi within the passenger front tire. Pressures above 20 psi correspond to overinflated tires while pressures low the 20 psi correspond to underinflated tires. The tire pressures in the remaining tires are set to the nominal tire pressures. The power spectral density is determined for accelerometer 4 in the Z-direction while the passenger front tire is in contact with the diagnostic cleat. The resulting average power spectral densities are plotted in FIG. 12. The passenger side plate responds at 40 Hz for the 5 psi tire pressure case because the tire pressure is so low that the vehicle operates entirely on the runflat component inside the tire. This characteristic is also observed in the vehicle response. The response of the passenger side plate is similar for the 20, 25, and 30 psi pressure cases.

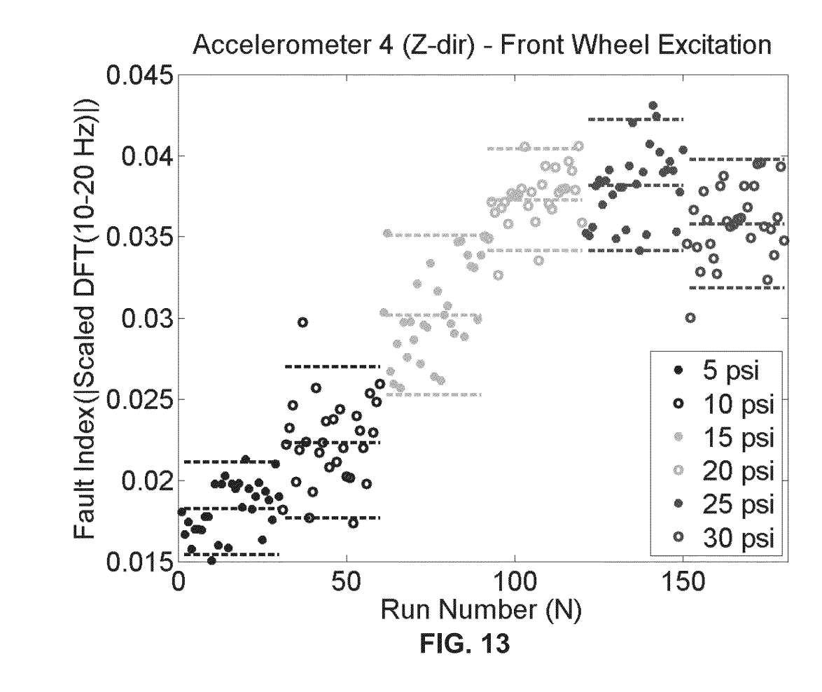

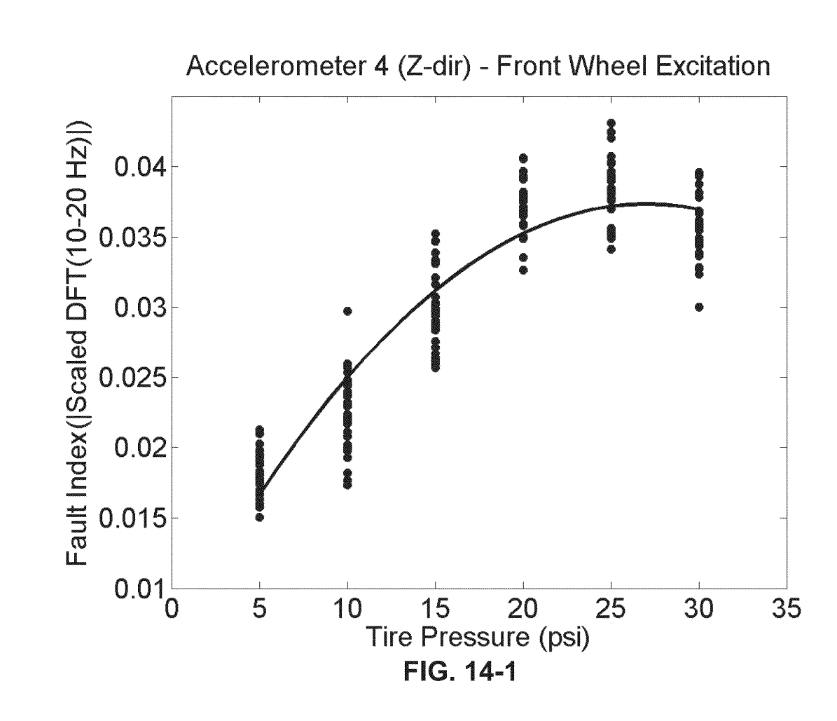

As the tire pressure is decreased in the passenger front tire, the magnitude of the response of the passenger side plate decreases between 10 and 20 Hz because the effectiveness of the tire decreases with tire pressure. The integral of the magnitude of the scaled DFT is estimated as follows to form a fault index (FI),

$$FI = {\sum }_{n = a}^{b} ‖ DFT ( n ) ‖ Δ f \qquad ( 3 )$$

where Δf is the frequency resolution, a is the lower frequency limit, and b is the upper frequency limit. The fault index from 10 to 20 Hz is determined for each run and plotted in FIG. 13 in order to analyze the effects of the reduction in tire pressure on the passenger side plate response. Based on this result, it is concluded that the fault index and tire pressure are related. The fault index is plotted versus tire pressure in FIG. 14-1 and a second order polynomial is fit to the data. The fault index is seen to remain constant between 20 and 25 psi, which is the nominal tire pressure for the HMMWV, and the fault index decreases somewhat at 30 psi.

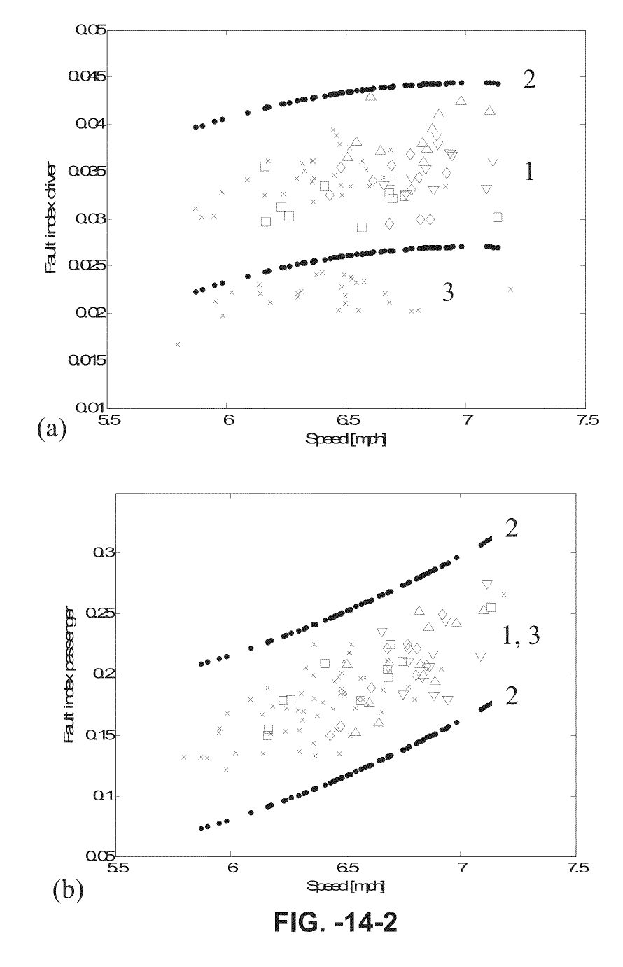

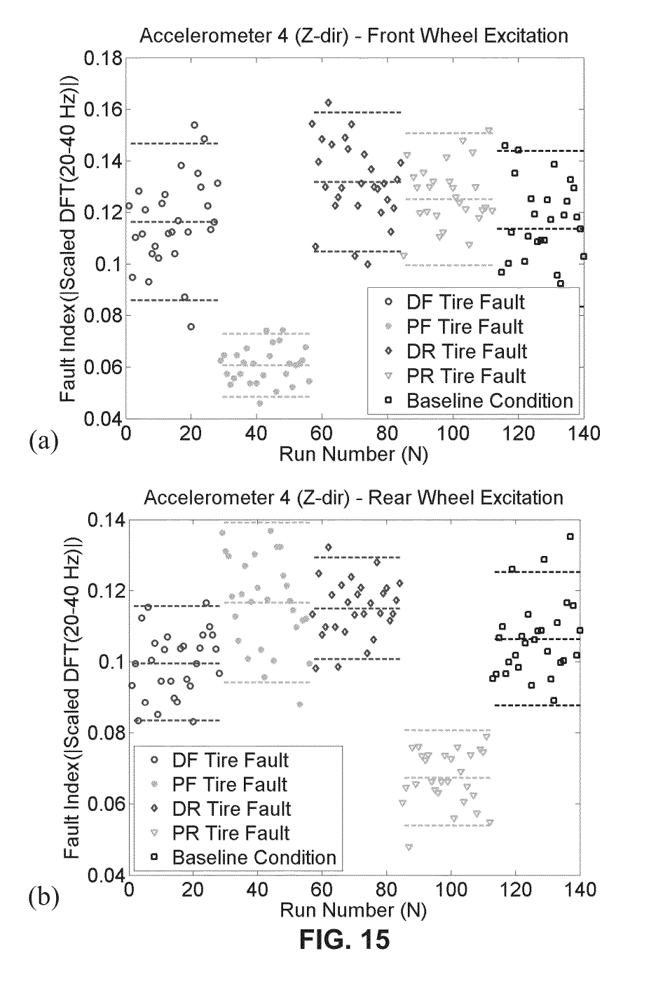

Tests are also conducted with tire faults, one at a time, in the driver's front, passenger's front, driver's rear, and passenger's rear tires. For each fault case, the tire containing the fault is filled to 10 psi and the remaining three tires are set to their nominal pressures. The fault index is then calculated from 20 to 40 Hz for each run using accelerometer 4 in the Z-direction for the passenger front and rear tire excitation measurements. The fault index results are plotted in FIG. 15 along with the mean and the prediction interval with the 90% confidence bands displayed for each data set. Both passenger side tire fault data sets are generally separated with 90% confidence from the remaining data sets for the data that is acquired when the faulty passenger tire is in contact with the diagnostic cleat.

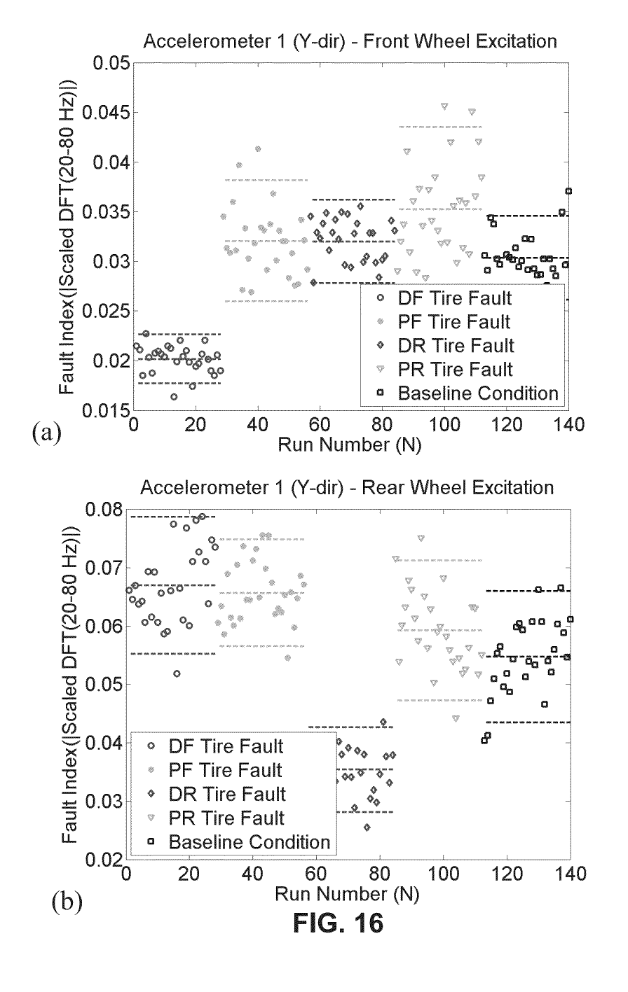

The fault index calculated from the magnitude of the scaled DFT from 20 to 80 Hz for each run is determined for accelerometer 1 in the Y-direction for the driver front and rear tire excitation measurements and the results are plotted in FIG. 16. As in the previous fault case, the driver side tire fault data sets are separated with 90% confidence from the remaining data sets. Suspension faults are simulated by disabling the dampers. The bolt located at the top of the shock tower that restrains the top of the damper is removed in order to disable the damper. The damper is then free to shift during testing. This approach for simulating a damper fault is nondestructive to the vehicle and produces a similar effect to the one that is obtained with a broken damper.

Front suspension faults are observed in the cleat response when either of the front vehicle tires is in contact with the diagnostic cleat, particularly when the front tire opposite to the side containing the suspension fault is simulated is in contact with the diagnostic cleat. For example, a driver front suspension fault has the greatest effect on the measured cleat response when the passenger front tire is in contact with the diagnostic cleat. These responses in the opposite side of the vehicle from which the suspension faults are simulated occur because a disabled damper causes the vehicle to roll excessively.

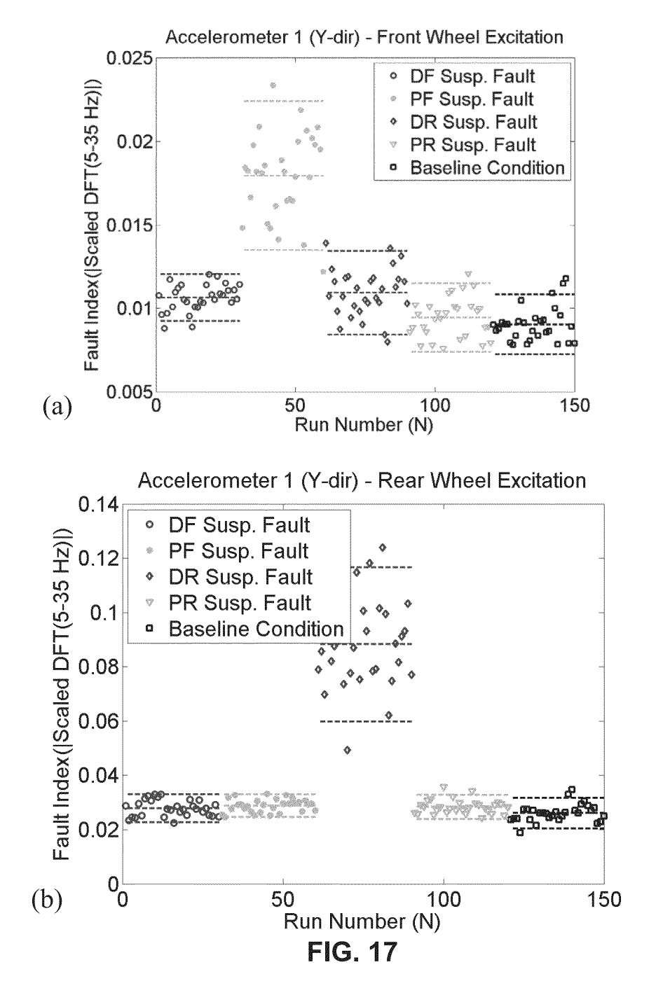

The fault index in some embodiments is calculated to identify the changes in the cleat response due to suspension faults. The fault index calculated from the magnitude of the scaled DFT from 5 to 35 Hz is determined for accelerometer 1 in the Y direction for each data set for the passenger front and rear tire excitation measurements, and the results are plotted in FIG. 17. The fault index for the passenger side plate response is able to separate, with 90% confidence, passenger front and driver rear suspension fault data sets.

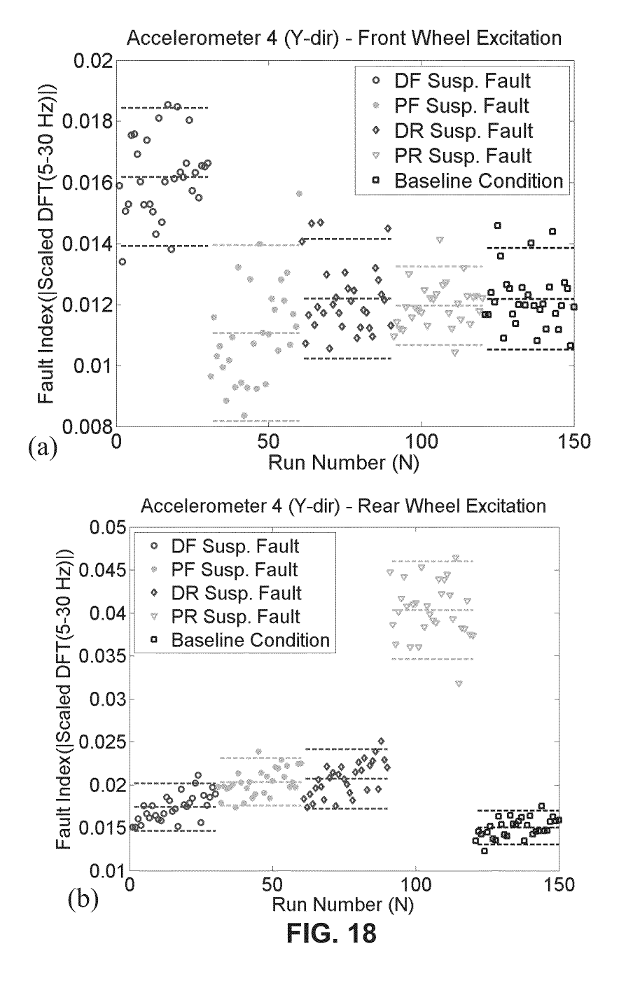

Likewise, the fault index calculated from the magnitude of the scaled DFT from 5 to 30 Hz is determined for accelerometer 4 in the Y direction for each data set for the passenger front and rear tire excitation measurements, and the results are plotted in FIG. 18. The fault index of the passenger side plate response is able to separate, with 90% confidence, the passenger rear suspension fault data sets. A different frequency range or another analysis technique can be used to separate this data set with a higher degree of confidence. However, the results presented here demonstrate that it is feasible to identify suspension faults in all four corners using the diagnostic cleat system.

A fault index according to yet another embodiment was extracted from the measured data for each dataset by calculating the sum of the spectral magnitudes for sensors 3 and 4 in the vertical direction across all three of these frequency ranges after the front wheels traversed the speed bump. The resulting fault indices were plotted in FIG. 14-2 for the driver (FIG. 14-2(a)) and passenger side (FIG. 14-2(b)) measurements. Note that the driver side fault index plot detects all of the 10 psi drive front tire pressure datasets (in red) because each of these datasets falls outside of the 99% confidence bands for the quadratic curve fit that was made using the baseline data (in blue). Also note that no averages were required to achieve detection of the faults that were simulated.

Although what has been shown and described are specific examples of various fault indices, it is understood that various other embodiments of the present invention contemplate other types of indices, and still other embodiments do not include calculation of any fault index. As one example, in some embodiments of the present invention the substantially raw accelerometer data, especially displayed on a graphical user interface 78, may provide sufficient information for an operator to identify a fault in the vehicle, or a condition of the vehicle. In still other embodiments, there is a fault index that includes phase angle information.

Some embodiments compensate for the variability due to temperature and humidity. Some embodiments compensate for the angle at which the axles of the vehicle cross the cleat. Some embodiments compensate for the vehicle speed. The speed is difficult for the driver to control and is subject to error given the approximate nature of the speedometer. All of the datasets have been taken using a nominal vehicle speed of 5 mph; however, there are small variations around this speed.

In one embodiment, the vehicle speed is estimated by calculating the time that passes between the instant when the front wheels first contact the instrumented plate and the instant when the rear wheels leave the plate. This elapsed time is used in some embodiments together with the vehicle wheelbase length and cleat length to estimate the average speed of the vehicle throughout the measurement process. In some embodiments, vehicle information such as wheelbase length and track width are inputs provided by an operator, especially through graphical user interface 78. Yet other embodiments include an additional sensor (such as a motion detector coupled to a cleat 50) to provide vehicle velocity data.

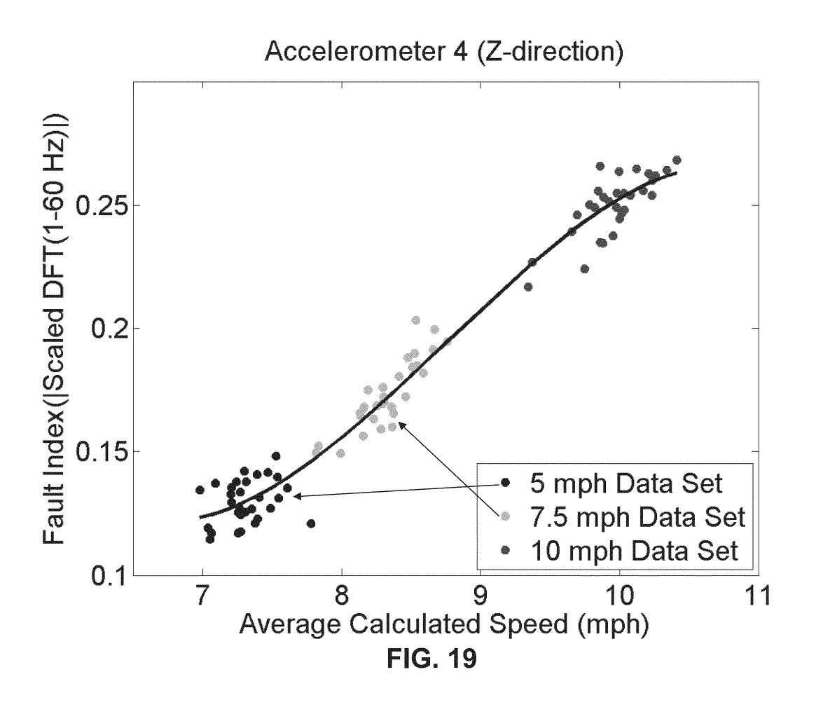

FIG. 19 shows a fault index according to one embodiment that is computed using the formula in Eq. (3) for accelerometer 3 in the Z direction for a number of datasets in which no faults are present in the tires or suspension of the vehicle. A third order polynomial is fitted to the data. These results indicate that there is variation in the target speeds of 5, 7.5, and 10 mph. The figure also indicates that the target speeds are not achieved using the speedometer on the dashboard due to errors in that reading. There is more variation in the fault index for the higher speed of 10 mph; therefore, the speed should be limited to 8 or 9 mph to avoid this high variation. FIG. 19 also indicates that the datasets with 7.5 mph as the target speed (in the center of the curve fit) are adequately modeled using this model. By utilizing this polynomial curve fit, modest changes in speed of the vehicle can be estimated and used to reduce the variability in the resulting fault index.

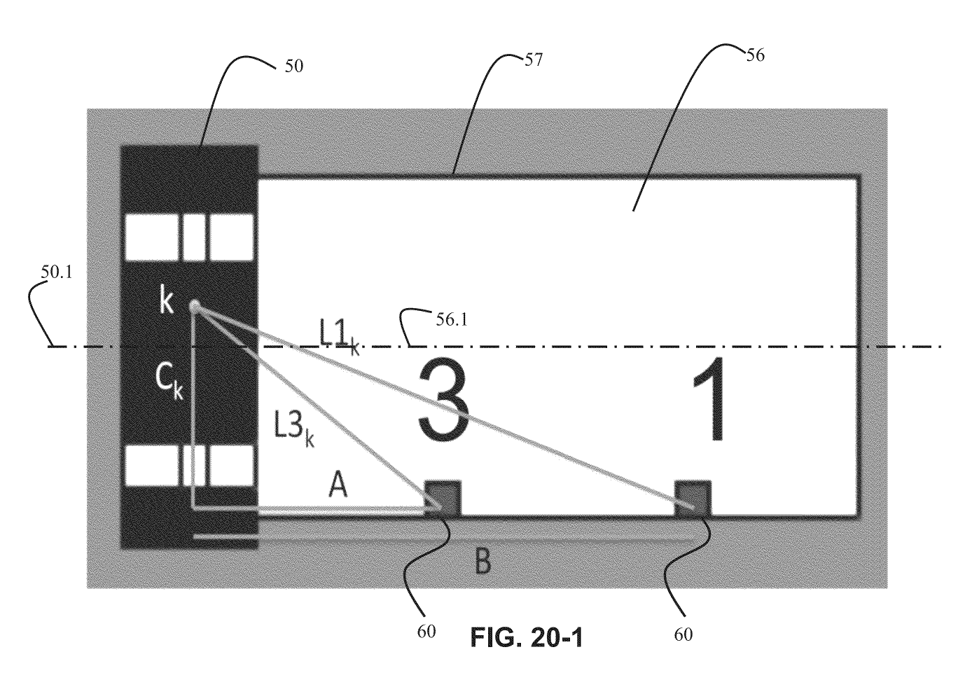

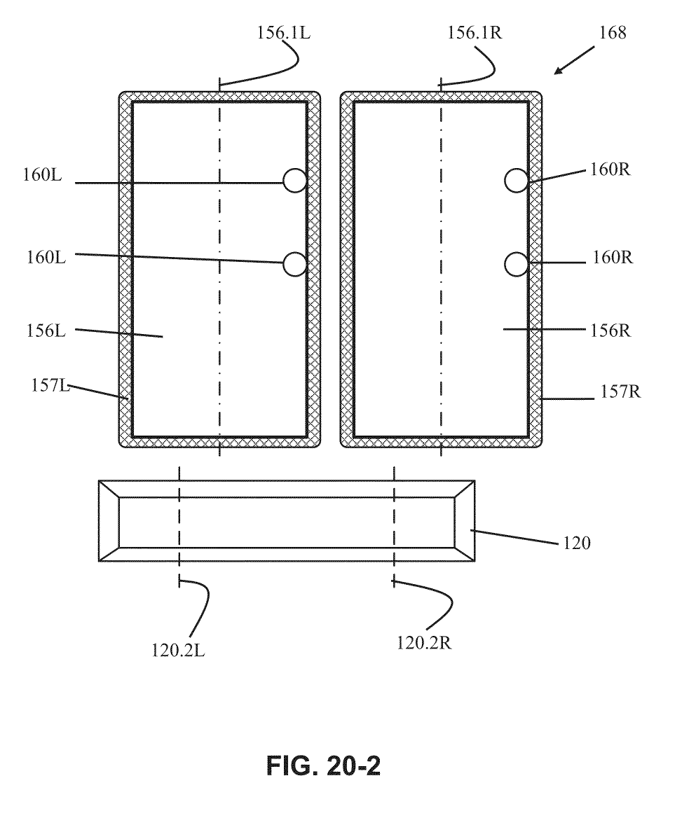

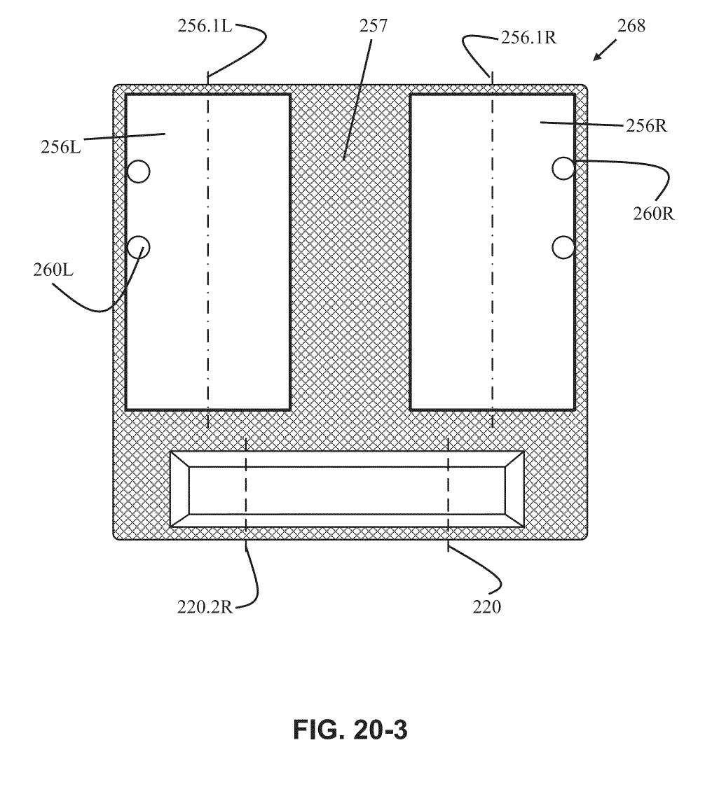

The wheels are preferably offset from the centerline 56.1 of plate 56 to excite a larger number of modes of vibration in the plate. Many of these mode shapes over a wide frequency range have symmetric shapes that have a nodes (points of no deflection when the plate is excited) along the geometric centerline 56.1 of each plate. If the wheels are driven down the center of the plate, these symmetric modes will not be excited which will reduce the response of the two plates. To avoid this, the plates are positioned so the wheels are off center and excite a larger number of modes of vibration in each plate. There can be two speed bumps 50R and 50L, sitting side by side as shown in FIG. 20-2, with the same profile so that each wheel is excited in the same manner. Each speed bump is preferably wider than the tires to insure that the speed bump contacts the entire tire surface every time a tire is driven over a speed bump.

FIG. 20-2 shows an arrangement of cleats and plates according to another embodiment of the present invention. FIG. 20-2 shows a portion of a system 168 for analyzing the condition of a vehicle. System 168 includes at least one elevational change 120 in the roadway, which can be a separable, resilient cleat. Cleat 120 is placed on the roadway such that the centerlines of the vehicle left and right tires align generally with lines 120.2L and 120.2R. This alignment can be emphasized to the driver of the vehicle by visual indicators which help the driver align the tires, or in some embodiments physical members in the roadway or cleat that provide tactile feedback to the driver through the steering wheel.

Arranged forward of cleat 120 in one embodiment are right and left members 156, each of which is isolated from the roadway by a corresponding mat 157 (shown in crosshatch). Preferably, mats 157 are sufficiently resilient to reduce the transmissibility of roadway vibratory motion into the plates 156.

Each plate 156 includes at least one sensor 160 placed proximate to an edge of the corresponding plate 156. In the embodiment shown in FIG. 20-2, each of the sensors 160L and 160R are located proximate to the right free edges of plates 156L and 156R, respectively. Preferably, each of the plates 156 is generally symmetric about a corresponding centerline 156.1L or 156.1R. The inner edge of plate 156L is spaced apart from the inner edge of plate 156R by a gap, which is helpful in reducing transmissibility of vibratory information laterally between the plates.

Further, it is preferred that each of the plates 156 are aligned relative to the left and right tracks of the vehicle. System 168 (which for the sake of clarity does not show the computer or display or cabling) includes a first plate 156L which is registered toward the right such that the left wheel path 120.2L extends generally to the left of centerline 156.1L. Therefore, the left tire of the vehicle is spaced apart from the center of the corresponding plate. FIG. 20-2 shows a plate 156R with similar orientation.

FIG. 20-3 shows a portion of a system 268 for analyzing the condition of a vehicle. System 268 includes at least one elevational change 220 in the roadway, which can be a separable, resilient cleat. Cleat 220 is placed on the roadway such that the centerlines of the vehicle left and right tires align generally with lines 220.2L and 220.2R. This alignment can be emphasized to the driver of the vehicle by visual indicators which help the driver align the tires, or in some embodiments physical members in the roadway or cleat that provide tactile feedback to the driver through the steering wheel.

Arranged forward of cleat 220 in one embodiment are right and left members 256, both of which is isolated from the roadway by a single mat 257 (shown in crosshatch). Preferably, mat 257 is sufficiently resilient to reduce the transmissibility of roadway vibratory motion into the plates 256.

Each plate 256 includes at least one sensor 260 placed proximate to an edge of the corresponding plate 256. In the embodiment shown in FIG. 20-3, each of the sensors 260L and 260R are located proximate to the outboard free edges of plates 256L and 256R, respectively. Preferably, each of the plates 256 is generally symmetric about a corresponding centerline 256.1L or 256.1R. The inner edge of plate 256L is spaced apart from the inner edge of plate 256R by a gap, which is helpful in reducing transmissibility of vibratory information laterally between the plates.

Further, it is preferred that each of the plates 256 are aligned relative to the left and right tracks of the vehicle. System 268 (which for the sake of clarity does not show the computer or display or cabling) includes a first plate 256L which is registered toward the left such that the left wheel path 220.2L extends generally to the right of centerline 256.1L. Therefore, the left tire of the vehicle is spaced apart from the center of the corresponding plate. FIG. 20-3 shows a plate 256R with similar orientation.

FIG. 20-1 shows a schematic of a wheel strike location on the speed bump relative to two sensors, 1 and 3, on the metal plate. FIG. 20-1 also shows the distances between that wheel strike on the sensor locations and was used to understand and motivate a change in how the extended cleats 50 and plates 56 are placed on the road. In some embodiments, instead of placing them such that the tires cross near the centerlines 56.1, which can lead to greater variability in the data, the plates 56 are located such that the tires drive across plate 56 in the upper part of the schematic, furthest away from the sensors. In yet other embodiments, the centerline 50.1 of cleat 50 is also located such that the tires are more likely to strike cleat 50 on the half of cleat 50 that is on the opposite side of the centerline 50.1. This placement reduces the variability in the distance from where the tires area rolling on the plate to the sensor locations between different test runs. In yet other embodiments, it is anticipated that the sensors can be placed on either the outboard or inboard edges of sensors 60 on the outboard or inboard edges of plate 56, with the centerline of the plate being located such that the tires roll on the half of the plate that is opposite to the edge where the sensors are located.

FIG. 21 shows a model that simulates the response of the vehicle and the plate, which is modeled using an elastically supported array of vibrating elements. The plate sensor 60 is indicated in the figure and describing

trends observed in the data. The subscript “s” refers to the sprung mass of the vehicle, the subscript “u” refers to the unsprung mass of the vehicle, and the subscript “p” refers to properties of the plate.

A fault index according to another embodiment can be calculated based on a cross correlation function between different axes of measurement and/or different wheels, such, as one example, as the Z and Y measurements on opposite wheels:

Fault index=RMS[R_{zy}(τ)]
where R_{zy}(τ)=E[z(t)y(t+τ)]
   This approach eliminates the need in some embodiments for a historical baseline by detecting “limping,” wherein the response data (such as the Z and Y measurements) for opposite wheels are more likely to indicate a fault than a comparison of response data for a single wheel to the historic baseline for that wheel. It is appreciated that present invention is not limited to any particular fault index, and yet other embodiments include cross correlations, including crosspower correlations, for any tire of the vehicle verses any other tire of the vehicle, and in any of the axes of measurement.

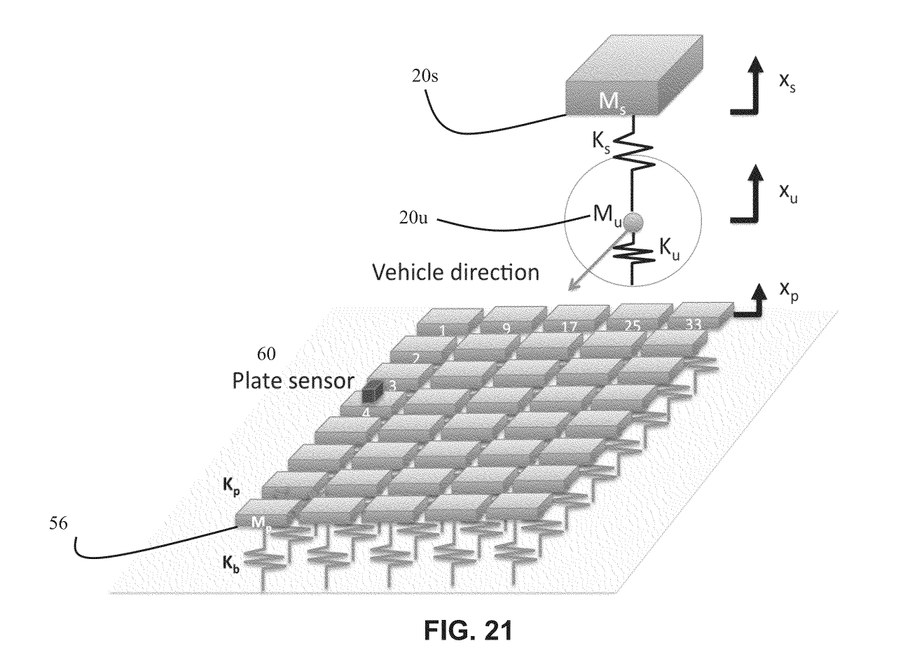

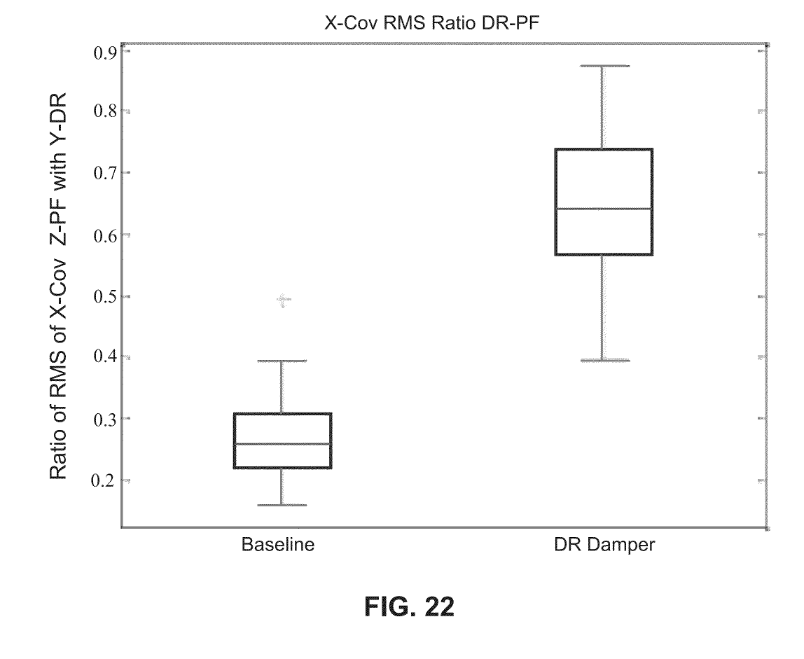

FIG. 22 is a plot of the cross correlation between the X and Y directions between opposite corners of the vehicle. In some embodiments the fault index is prepared to identify the situation where one damper is damaged in one corner, and the vehicle will “limp.” The X and Y direction correlation will indicate the limping. FIG. 22 shows a cross correlation of passenger front wheel to driver rear wheel, using X-axis data for one corner and Y-axis data for the other corner.

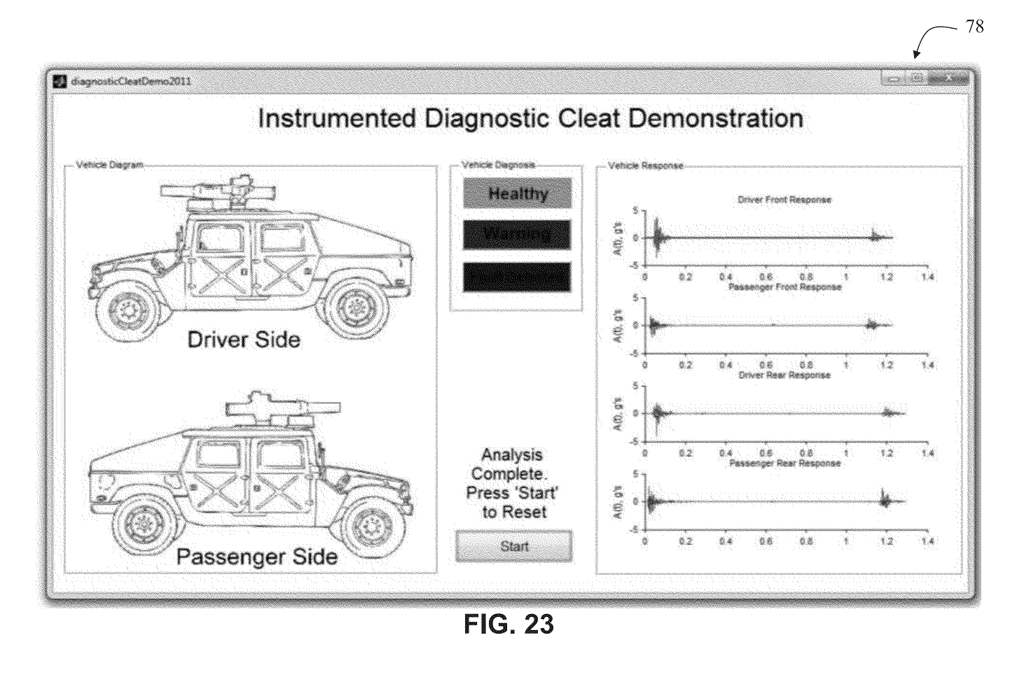

FIGS. 23-25 show the graphical user interface (GUI) that was developed to give the user a way to start the data acquisition system, collect data, view the time data. It also provides an output to the operator showing the state of the vehicle, the location of a fault if present in the vehicle tested and the type of fault.

FIG. 23 shows a graphical user interface 78 provided on a display 76 being driven by computer 70. GUI 78 includes at least one depiction of a side of a vehicle. Preferably, the vehicle depicted is the same vehicle as the one being tested. GUI 78 shows the left side 78.1L of vehicle 20 and the right side 78.1R of vehicle 20. The central portion of GUI 78 preferably includes one or more buttons used to operate the computer 70 software 80. Further, GUI preferably includes one or more indicators (as shown in FIG. 23, located in the center toward the top) to provide an overall indication of the health of the vehicle. GUI 78 further includes a display 78.2 of information taken from one or more of the motion sensors 60.

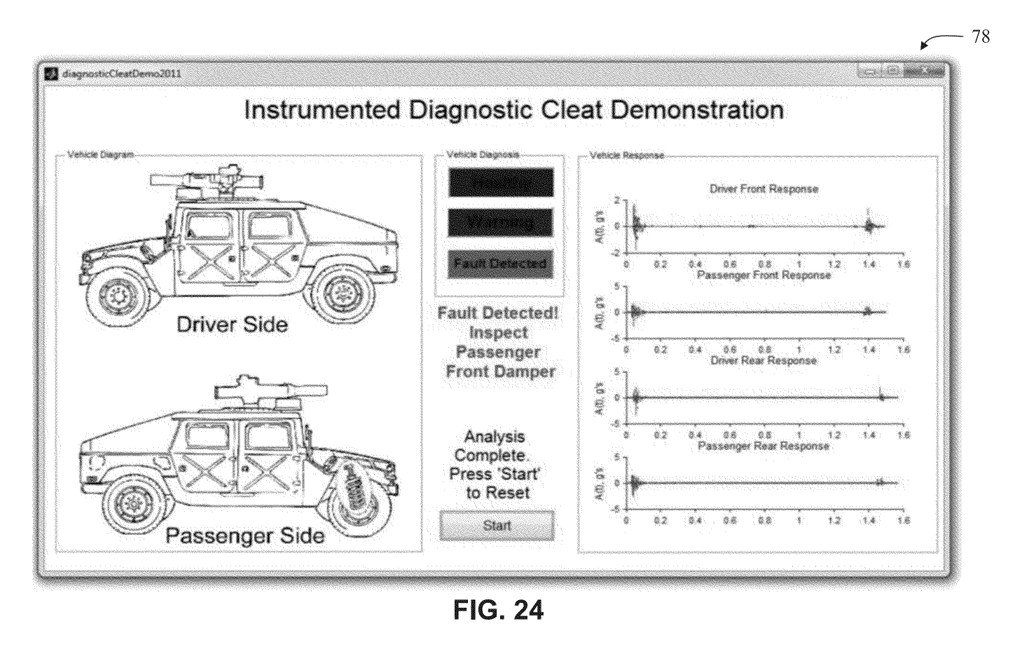

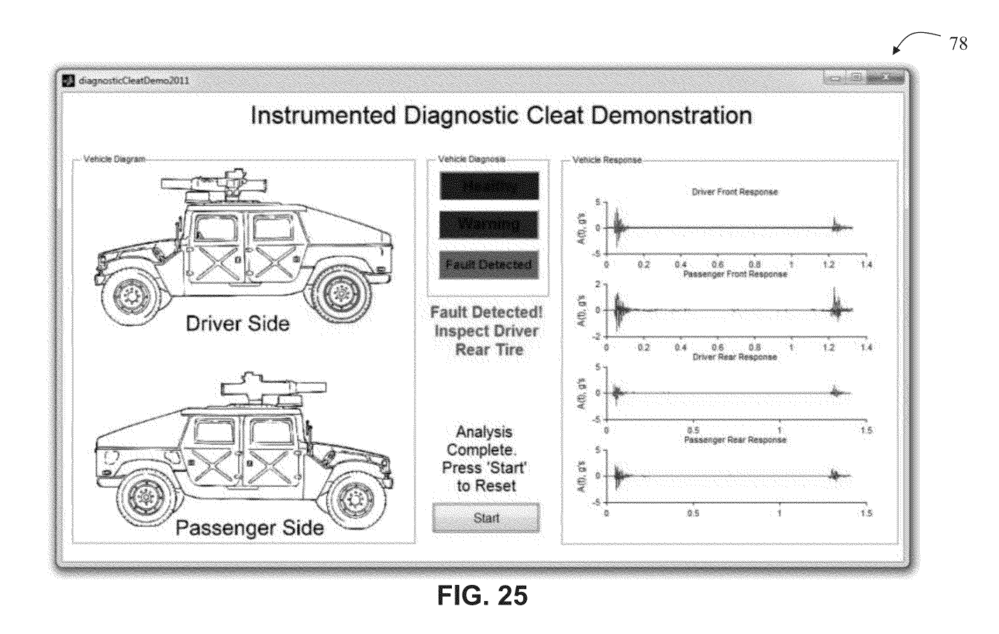

FIG. 24 shows another state of GUI 78 in which a condition of the vehicle has been detected. In one embodiment, this condition is a fault associated with the right side shock absorber. In such embodiments, GUI 78 displays the right side of the vehicle and further provides specific information as to a fault component. In some embodiments this information is a graphical depiction of the component, but could also be an area of the display in a different color, a different intensity, or the like. The central warning indicators show that a fault has been detected, and further provide information as to specifics of the fault. The right side of GUI 78 in FIG. 24 further displays data associated with the faulted condition. FIG. 25 presents yet another state of GUI 78 in which a tire on the left rear side has been indicated as having a faulted condition.

Various aspects of different embodiments of the present invention are expressed in paragraphs X1, X2, and X3, as follows:

X1. One aspect of the present invention pertains to an apparatus for analyzing a vehicle. The method preferably includes a first portable segment of driving surface, said first segment having a top surface adapted and configured to be driven on by a wheeled vehicle, said first segment having a cross-sectional shape adapted and configured to locally elevate a vehicle driven over said first segment. The apparatus preferably includes a second separable segment of driving surface, said second segment having a top surface adapted and configured to be driven on by a wheeled vehicle, said second segment being located proximate to said first segment. The apparatus preferably includes a motion sensor providing a signal corresponding to motion of said second segment. The apparatus preferably includes a computer receiving the signal and having software that analyzes the signal.

X2. Another aspect of the present invention pertains to a method for analyzing a vehicle on a roadway. The method preferably includes providing a segment of driving surface located proximate to a local elevational change in the roadway, and a sensor providing a signal corresponding to the spatial response of the segment. The method preferably includes driving the vehicle first over the elevational change. The method preferably includes driving the responding vehicle over the segment. The method preferably includes recording the signal during said driving over the segment. The method preferably includes correcting the recorded signal for the response of the vehicle.

X3. Another aspect of the present invention pertains to an apparatus for analyzing a wheeled vehicle having a wheelbase and a front track. The apparatus preferably includes a first member adapted and configured to be driven on by the vehicle, said first panel having a width less than the front track and a length less than the wheelbase. The apparatus preferably includes a second panel having a substantially flat top surface adapted and configured to be driven on by the vehicle. The apparatus preferably includes a first motion sensor attached to said first panel and providing a signal corresponding to motion of said first panel. The method preferably includes a second motion sensor attached to said second panel and providing a signal corresponding to motion of said second panel.

Yet other embodiments pertain to any of the previous statements X1, X2, or X3, which are combined with one or more of the following other aspects:

Wherein the motion sensor is attached to said second segment.

Wherein the motion sensor is one of a displacement sensor, a velocity sensor, or an acceleration sensor.

Wherein said second segment has a substantially flat top surface.

Wherein said second segment is not attached to the roadway.

Which further comprises means for isolating said second segment from the roadway.

Wherein said second segment is supported from the roadway by resilient material.

Wherein the resilient material is a layer of an elastomeric material

Wherein the resilient material comprises a plurality of spaced apart elastomeric members.

Which further comprises calculating a velocity of the vehicle driving over the segment from the signal, and said correcting based on the velocity over the segment. which further comprises determining a condition of the vehicle from the corrected signal.

Wherein the condition is a tire with low air pressure or a worn shock absorber. which further comprises analyzing the corrected signal and recommending maintenance to the vehicle from said analyzing.

Which further comprises preparing a fault index from the corrected signal.

Wherein said preparing is from the signal in the time domain or frequency domain.

Wherein the response is pitching or rolling of the vehicle.

Wherein the vehicle response is a fundamental mode of rigid body motion.

Wherein the response of the vehicle is below a frequency, and said correcting is by removing frequency content of the signal below the frequency.

Wherein the segment responds in a vibratory mode above a frequency, and said correcting is by removing frequency content of the signal above the frequency.

Wherein said correcting is with a bandpass filter.

Which further comprises not attaching the segment to the roadway.

Which further comprises supporting the segment on the road with a resilient material.

Which further comprises isolating the segment from responses of the roadway.

Wherein the elevational change is a rise in the level of the roadway and the portable segment is substantially flat.

Wherein the elevational change is one of an asphalt or concrete speed bump. wherein the elevational change is a reduction in the level of the roadway.

Wherein the elevational change is a second portable segment of roadway.

Wherein said first panel and said second panel are placed side by side on a roadway with a gap between the interior edges of said first and second panels.

Wherein the length of said first panel is greater than the circumference of a tire of the vehicle.

Which further comprises a third motion sensor attached to said first panel and providing a signal corresponding to motion of said first panel, said third sensor being spaced apart from said first sensor along the length of said first panel.

A fourth motion sensor attached to said second panel and providing a signal corresponding to motion of said second panel;

Wherein the first panel is fabricated from one of aluminum or steel.

Which further comprises a first isolating member adapted and configured to be placed between said first panel and a roadway.

Wherein said isolating member is a resilient pad of about the same length and width as said first panel.

Wherein said first panel has an edge, and said first sensor is placed proximate to the edge of said first panel, and said second panel has an edge, and said second sensor is placed proximate to the edge of said second panel.

Wherein the fault index is a cross correlation of response data along different axes of measurement.

Wherein the fault index is a cross correlation of response data of different wheels.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. An apparatus for analyzing a vehicle, comprising:
a first separable segment of driving surface, said first segment having a top surface adapted and configured to be driven on by a wheeled vehicle, said first segment having a cross-sectional shape adapted and configured to locally elevate a vehicle driven over said first segment;
a second separable segment of driving surface, said second segment having a top surface adapted and configured to be driven on by a wheeled vehicle, said second segment being located proximate to said first segment;
a motion sensor providing a signal corresponding to motion of said second segment; and
a computer receiving the signal and having software that analyzes the signal.

2. The apparatus of claim 1 wherein said second segment is supported from the roadway by resilient material.

3.-4. (canceled)

5. The apparatus of claim 1 which further comprises means for isolating said second segment from the roadway.

6. The apparatus of claim 1 wherein said second segment is not attached to the roadway.

7. (canceled)

8. The apparatus of claim 1 wherein said second segment has a length, and the length is less than the wheelbase of the vehicle.

9. The apparatus of claim 1 wherein said first segment has a bottom side adapted and configured to be placed on the surface of a roadway.

10. The apparatus of claim 1 wherein the motion sensor is attached to said second segment.

11. (canceled)

12. The apparatus of claim 1 wherein said first segment is sufficiently flexible to generally conform to the surface of the roadway.

13. A method for analyzing a vehicle on a roadway, comprising the acts of:
providing a separable segment of driving surface located proximate to a local elevational change in the roadway, and a sensor providing a signal corresponding to the spatial response of the segment,
driving the vehicle first over the elevational change at a vehicle velocity sufficient to cause vehicle response in at least one of pitching motion or rolling motion;
driving the responding vehicle over the segment;
recording the signal during said driving over the segment; and
correcting the recorded signal for one of the response of the vehicle or the response of the segment.

14. The method of claim 13 wherein the pitching or rolling response of the vehicle is below a frequency, and said correcting is by removing frequency content of the signal below the frequency.

15. The method of claim 13 wherein the segment responds in a vibratory mode above a frequency, and said correcting is by removing frequency content of the signal above the frequency.

16. (canceled)

17. The method of claim 13 wherein the vehicle response is a fundamental mode of rigid body motion.

18.-19. (canceled)

20. The method of claim 13 wherein said correcting is of the response of the vehicle and which further comprises preparing a fault index from the corrected signal.

21.-22. (canceled)

23. The method of claim 13 which further comprises calculating a velocity of the vehicle driving over the segment from the signal, and said correcting based on the velocity over the segment.

24.-26. (canceled)

27. The method of claim 13 which further comprises analyzing the corrected signal and recommending maintenance to the vehicle from said analyzing.

28. The method of claim 13 which further comprises not attaching the segment to the roadway.

29. The method of claim 13 which further comprises supporting the segment on the road with a resilient material.

30. (canceled)

31. The method of claim 13 wherein the elevational change is a rise in the level of the roadway and the portable segment is substantially flat.

32.-34. (canceled)

35. An apparatus for analyzing a wheeled vehicle having a wheelbase and a front track, comprising:
a first panel having a substantially flat top surface adapted and configured to be driven on by the vehicle, said first panel having a width less than the front track and a length less than the wheelbase;
a second panel having a substantially flat top surface adapted and configured to be driven on by the vehicle, said second panel having a width less than the front track and a length less than the wheelbase;
a first motion sensor attached to said first panel and providing a signal corresponding to motion of said first panel; and
a second motion sensor attached to said second panel and providing a signal corresponding to motion of said second panel;

36. The apparatus of claim 35 wherein said first panel and said second panel are placed side by side on a roadway with a gap between the interior edges of said first and second panels.

37. The apparatus of claim 35 wherein the length of said first panel is greater than the circumference of a tire of the vehicle.

38. The apparatus of claim 35 wherein said first panel has an edge, and said first sensor is placed proximate to the edge of said first panel, and said second panel has an edge, and said second sensor is placed proximate to the edge of said second panel.

39.-41. (canceled)

42. The apparatus of claim 35 which further comprises a first isolating member adapted and configured to be placed between said first panel and a roadway.

43.-51. (canceled)

52. A system for analyzing a wheeled vehicle having a wheel track, comprising:
a right panel having a top surface adapted and configured to be driven on by the right side of the vehicle, said right panel having a width less than the wheel track;
a left panel having a top surface adapted and configured to be driven on by the left side of the vehicle, said left panel having a width less than the wheel track, said left panel being located on a roadway adjacent to and spaced apart from said right panel;
a right motion sensor providing a signal corresponding to motion of said right panel; and
a left motion sensor providing a signal corresponding to motion of said left panel;
a computer receiving the right motion signal and the left motion signal and having software that determines a condition of a side of the vehicle;
a display driven by said computer and having a graphical user interface showing the side of a vehicle and providing information about the condition.

53. The system of claim 52 wherein the side that is shown includes a graphical depiction of the condition.

54.-55. (canceled)
